(19) United States
(12) Patent Application Publication
(10) Pub. No.: US 2025/0164695 A1
(43) Pub. Date: May 22, 2025

(54) SYSTEMS AND METHODS FOR IMPROVED OPTICAL SYSTEMS

(71) Applicant: Meta Platforms Technologies, LLC, Menlo Park, CA (US)

(72) Inventors: Prathmesh Deshmukh, Redmond, WA (US); Tingling Rao, Bellevue, WA (US); Zhaoyu Nie, Redmond, WA (US); Andrew John Ouderkirk, Kirkland, WA (US); Jie Li, Petaluma, CA (US); Yuanrui Li, Menlo Park, CA (US); Jianji Yang, Cupertino, CA (US); Zhenye Li, Redmond, WA (US); Sawyer Miller, Bellevue, WA (US); Xuan Wang, Kirkland, WA (US); Joshua Cobb, Victor, NY (US); Hsien-Hui Cheng, Woodinville, WA (US); Eugene Cho, Seattle, WA (US); Robin Sharma, Woodinville, WA (US); Eric Stratton, Snohomish, WA (US); Ajit Ninan, San Jose, CA (US); Zhexin Zhao, Redmond, WA (US); Xiayu Feng, Kirkland, WA (US); Yun-Han Lee, Redmond, WA (US); Michael Escuti, Redmond, WA (US); Steven John Robbins, Redmond, WA (US); Babak Amirsolaimani, Redmond, WA (US); Lu Lu, Kirkland, WA (US); Barry David Silverstein, Kirkland, WA (US)

(21) Appl. No.: 18/785,679

(22) Filed: Jul. 26, 2024

Related U.S. Application Data
(60) Provisional application No. 63/601,360, filed on Nov. 21, 2023.
(60) Provisional application No. 63/601,368, filed on Nov. 21, 2023.
(60) Provisional application No. 63/603,784, filed on Nov. 29, 2023.
(60) Provisional application No. 63/613,612, filed on Dec. 21, 2023.
(60) Provisional application No. 63/601,357, filed on Nov. 21, 2023.
(60) Provisional application No. 63/609,972, filed on Dec. 14, 2023.

(51) Int. Cl. G02B 6/27; G02B 6/34; G02B 27/01; G06F 1/16

(52) U.S. Cl. CPC G02B 6/2726; G02B 6/34; G06F 1/163; G02B 27/0172; G02B 2027/0178

(57) ABSTRACT

An optical element includes a waveguide body that is configured to guide light by total internal reflection from an input end to an output end, an input coupling element located at the input end for coupling light into the waveguide body, and an output coupling element located at the output end for coupling light out of the waveguide body, where the waveguide body includes an organic solid crystal. The organic solid crystal may be a single crystal having principal axes rotated with respect to the dimensions of the waveguide body. Such an optical element may have low weight and exhibit good color uniformity while providing polarization scrambling of the guided light.

### CROSS-REFERENCE TO RELATED APPLICATIONS

This application claims priority to U.S. Application 63/601,360, filed 21 Nov. 2023, U.S. Application No. 63/601,368, filed 21 Nov. 2023, U.S. Application No. 63/603,784, filed 29 Nov. 2023, U.S. Application No. 63/609,972, filed 14 Dec. 2023, and U.S. Application No. 63/613,612, filed 21 Dec. 2023, and U.S. Application No. 63/601,357, filed 21 Nov. 2023, the disclosures of each of which are incorporated, in their entirety, by this reference.

### BRIEF DESCRIPTION OF THE DRAWINGS

The accompanying drawings illustrate a number of exemplary embodiments and are a part of the specification. Together with the following description, these drawings demonstrate and explain various principles of the present disclosure.

FIG. 1 is an isometric view of an example organic solid crystal substrate according to some embodiments.

FIG. 2 is a schematic diagram showing an organic solid crystal-based planar waveguide according to some embodiments.

FIG. 3 shows cross-sectional views of polarization scrambling within an organic solid crystal according to some embodiments.

FIG. 4 illustrates simulations of light propagation within planar waveguides including isotropic or anisotropic media according to some embodiments.

FIG. 5 is a schematic diagram showing further organic solid crystal-based planar waveguides according to some embodiments.

FIG. 6 is an illustration of exemplary augmented-reality glasses that may be used in connection with embodiments of this disclosure.

FIG. 7 is an illustration of an exemplary virtual-reality headset that may be used in connection with embodiments of this disclosure.

FIG. 8 is a diagram of a head-mounted display (HMD) that includes a near-eye display (NED) according to some embodiments.

FIG. 9 is a cross-sectional view of the HMD illustrated in FIG. 8 according to some embodiments.

FIG. 10 illustrates an isometric view of a waveguide display in accordance with various embodiments.

FIG. 11 is a cross-sectional view of a waveguide display according to some embodiments.

FIG. 12 shows an example waveguide display including an array of decoupling elements each having an over-formed reflector according to various embodiments.

FIG. 13 shows an example waveguide display including an array of decoupling elements each having an over-formed reflector according to further embodiments.

FIG. 14 is a schematic diagram of a portion of an LCD display showing the co-integration of an in-plane switching element with the display element according to some embodiments.

FIG. 15 illustrates the effects on accommodation of incorporating an in-plane switching element into the LCD display of FIG. 14 according to some embodiments.

FIG. 16 is a schematic diagram of a portion of an LCD display showing the co-integration of an in-plane switching within the display optics according to certain embodiments.

FIG. 17 is a schematic diagram of a portion of an LCD display showing the co-integration of an in-plane switching element within the display optics according to further embodiments.

FIG. 18 shows aspects of polarization aberration correction according to some embodiments.

FIG. 19 is a schematic diagram of a foveated display including polarization multiplexing according to some embodiments.

FIG. 20 is an illustration of an example varifocal display with a pancake lens and a micro lens array.

FIG. 21 is an illustration of an example light field display with a pancake lens and a micro lens array.

FIGS. 22A, 22B, and 22C are illustrations of a liquid micro lens array in various actuation states.

FIGS. 23A and 23B are illustrations of a liquid micro lens array on a liquid lens in various actuation states.

FIGS. 24A, 24B, and 24C are illustrations of an example liquid-crystal based micro lens array.

FIG. 25 is an illustration of example haptic devices that may be used in connection with embodiments of this disclosure.

FIG. 26 is an illustration of an example virtual-reality environment according to embodiments of this disclosure.

FIG. 27 is an illustration of an example augmented-reality environment according to embodiments of this disclosure.

FIG. 28 an illustration of an example system that incorporates an eye-tracking subsystem capable of tracking a user's eye(s).

FIG. 29 is a more detailed illustration of various aspects of the eye-tracking subsystem illustrated in FIG. 28.

FIG. 30 is a schematic diagram of a diffractive waveguide combiner system according to some embodiments.

FIG. 31 is an illustration of the scattering channels of an input grating at the air-waveguide interface according to some embodiments.

FIG. 32 depicts the amplitude of incident and guided light interacting with an input grating and a polarization controlling coating according to certain embodiments.

FIG. 33 is a table showing the maximum guided power after two interactions with an input grating according to various embodiments.

FIG. 34 is a schematic view of the projected incident pupil on an input grating for the first and subsequent interactions, and the segmentation of the incident pupil with respect to the number of interactions within the input grating according to some embodiments.

FIG. 35 is a plot of normalized k-space for a 50×50 FOV at 532 nm and a representation of the pupil segmentation according to some embodiments.

FIG. 36 shows plots of optimal grating diffraction efficiency and optimal input efficiency for a polarization insensitive grating according to certain embodiments.

FIG. 37 shows plots of optimal grating diffraction efficiency and optimal input efficiency for unpolarized input light according to some embodiments.

FIG. 38 shows plots of optimal grating diffraction efficiency and optimal input efficiency for polarized input light according to some embodiments.

FIG. 39 shows plots of diffraction efficiency and input efficiency versus FOV according to various embodiments.

FIG. 40 is a table summarizing the harmonic mean input efficiency and minimum-to-maximum uniformity of an input grating according to some embodiments.

FIG. 41 shows the harmonic mean input efficiency as a function of waveguide thickness for example embodiments.

FIG. 42 is a plot of the harmonic mean input efficiency as a function of projector pupil diameter according to some embodiments.

FIG. 43 is a plot of the harmonic mean input efficiency as a function of projector pupil relief distance according to some embodiments.

FIG. 44 is a diagram summarizing a theoretical model for evaluating input grating efficiency according to particular embodiments.

Throughout the drawings, identical reference characters and descriptions indicate similar, but not necessarily identical, elements. While the exemplary embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the present disclosure covers all modifications, equivalents, and alternatives falling within the scope of the appended claims.

### DETAILED DESCRIPTION OF EXEMPLARY EMBODIMENTS

### Organic Solid Crystal Polarization Scrambler

Polymer and other organic materials may be incorporated into a variety of different optic and electro-optic device architectures, including passive and active optics and electroactive devices. Lightweight and conformable, one or more polymer/organic solid layers may be incorporated into wearable devices such as smart glasses and are attractive candidates for emerging technologies including virtual reality/augmented reality devices where a comfortable, adjustable form factor is desired.

Virtual reality (VR) and augmented reality (AR) eyewear devices or headsets, for instance, may enable users to experience events, such as interactions with people in a computer-generated simulation of a three-dimensional world or viewing data superimposed on a real-world view. By way of example, superimposing information onto a field of view may be achieved through an optical head-mounted display (OHMD) or by using embedded wireless glasses with a transparent heads-up display (HUD) or augmented reality (AR) overlay. VR/AR eyewear devices and headsets may be used for a variety of purposes. Governments may use such devices for military training, medical professionals may use such devices to simulate surgery, and engineers may use such devices as design visualization aids.

As will be appreciated, in various optical devices, including refractive waveguide-based display systems, polarization variances and attendant coherent interference effects can hamper performance. Moreover, polarization scrambling techniques based on solid state materials such as LiNbO₃ are customarily bulky, slow, narrow band, and expensive. In view of the foregoing, it would be advantageous to provide materials and designs for refractive waveguide-based display systems to mitigate the unwanted generation of coherence artifacts.

Organic solid crystals (OSCs) provide a new design space for optical systems. Organic solid crystal (OSC) materials can be used in various optical components, including surface relief gratings, meta-surfaces, waveguides, beam splitting, photonic elements such as photonic integrated circuits, and polarization selective elements. For instance, an augmented reality display may include an OSC-based waveguide where an OSC layer constitutes the light propagation medium.

Organic solid crystals have a unique value proposition for use in diffractive optical elements, such as a planar diffractive waveguide. An example waveguide includes a longitudinally extending high-index optical medium, which is transversely encased by low-index media or cladding. During use, a guided optical wave propagates in the waveguide through the high-index core along the longitudinal direction. In accordance with various embodiments, the high-index core of such a waveguide may be formed from or include an organic solid crystal (OSC). Such a construction may beneficially impact one or more of the display field of view, uniformity, efficiency, and cost of manufacture.

With high refractive index, high birefringence, and large order crystallinity, OSCs having a specified orientation of principal indices may be incorporated into the optical path of a diffractive waveguide and, through multiple bifurcating interactions, induce polarization scrambling (randomization of polarization) of a beam of light as it travels therethrough. An organic solid crystal layer may be configured to randomize the instantaneous polarization state of light within the waveguide to achieve a time-averaged depolarization effect. OSC-based waveguides may exhibit a large operational bandwidth and low loss across visible and IR regions.

One or more source materials may be used to form an organic solid crystal, including an OSC substrate. Example organic materials include various classes of crystallizable organic semiconductors. Organic semiconductors may include small molecules, macromolecules, liquid crystals, organometallic compounds, oligomers, and polymers. Organic semiconductors may include p-type, n-type, or ambipolar polycyclic aromatic hydrocarbons, such as anthracene, phenanthrene, polycene, triazole, tolane, thiophene, pyrene, corannulene, fluorene, biphenyl, ter-phenyl, etc. Further example small molecules include fullerenes, such as carbon 60.

Example source material compounds may include cyclic, linear and/or branched structures, which may be saturated or unsaturated, and may additionally include heteroatoms and/or saturated or unsaturated heterocycles, such as furan, pyrrole, thiophene, pyridine, pyrimidine, piperidine, and the like. Heteroatoms (e.g., dopants) may include fluorine, chlorine, nitrogen, oxygen, sulfur, phosphorus, as well as various metals. Suitable feedstock for depositing solid organic semiconductor materials may include neat organic compositions, melts, solutions, or suspensions containing one or more of the organic materials disclosed herein.

OSC materials may provide functionalities, including phase modulation, beam steering, wave-front shaping and correction, optical communication, optical computation, holography, and the like. Due to their optical and mechanical properties, organic solid crystals may enable high-performance devices, and may be incorporated into passive or active optics, including AR/VR headsets, and may replace comparative material systems such as polymers, inorganic materials, and liquid crystals. In certain aspects, organic solid crystals may have optical properties that rival those of inorganic crystals while exhibiting the processability and electrical response of liquid crystals.

Structurally, the disclosed organic materials may be glassy, polycrystalline, or single crystal. Organic solid crystals, for instance, may include closely packed structures (e.g., organic molecules) that exhibit desirable optical properties such as a high and tunable refractive index, and high birefringence. Anisotropic organic solid materials may include a preferred packing of molecules, i.e., a preferred orientation or alignment of molecules. Example devices may include one or more organic solid crystal thin film or substrate having a high refractive index that may be further characterized by a smooth exterior surface.

High refractive index and highly birefringent organic semiconductor materials may be manufactured as a free-standing article or as a thin film deposited onto a substrate. An epitaxial or non-epitaxial growth process, for example, may be used to form an organic solid crystal (OSC) layer over a suitable substrate or within a mold. A seed layer for encouraging crystal nucleation and an anti-nucleation layer configured to locally inhibit nucleation may collectively promote the formation of a limited number of crystal nuclei within specified locations, which may in turn encourage the formation of larger organic solid crystals.

As used herein, the terms “epitaxy,” “epitaxial” and/or “epitaxial growth and/or deposition” refer to the nucleation and growth of an organic solid crystal on a deposition surface where the organic solid crystal layer being grown assumes the same crystalline habit as the material of the deposition surface. For example, in an epitaxial deposition process, chemical reactants may be controlled, and the system parameters may be set so that depositing atoms or molecules alight on the deposition surface and remain sufficiently mobile via surface diffusion to orient themselves according to the crystalline orientation of the atoms or molecules of the deposition surface. An epitaxial process may be homogeneous or heterogeneous.

In some embodiments, the organic crystalline phase may be isotropic (n₁=n₂=n₃) or birefringent, where n₁≠n₂≠n₃, or n₁≠n₂=n₃, or n₁=n₂≠n₃, and may be characterized by a birefringence (Dn) between at least one pair of orientations of at least approximately 0.1, e.g., at least approximately 0.1, at least approximately 0.2, at least approximately 0.3, at least approximately 0.4, or at least approximately 0.5, including ranges between any of the foregoing values. In some embodiments, a birefringent organic crystalline phase may be characterized by a birefringence of less than approximately 0.1, e.g., less than approximately 0.1, less than approximately 0.05, less than approximately 0.02, less than approximately 0.01, less than approximately 0.005, less than approximately 0.002, or less than approximately 0.001, including ranges between any of the foregoing values. The OSC substrate may have principal refractive indices (n₁, n₂, n₃) where n₁, n₂, and n₃ may independently vary from approximately 1.0 to approximately 4.0.

Organic solid crystal materials, including multilayer organic solid crystal thin films or substrates, may be optically transparent and exhibit low bulk haze. As used herein, a material or element that is “transparent” or “optically transparent” may, for a given thickness, have a transmissivity within the visible light spectrum of at least approximately 80%, e.g., approximately 80, 90, 95, 97, 98, 99, or 99.5%, including ranges between any of the foregoing values, and less than approximately 5% bulk haze, e.g., approximately 0.1, 0.2, 0.4, 1, 2, or 4% bulk haze, including ranges between any of the foregoing values. Transparent materials will typically exhibit very low optical absorption and minimal optical scattering.

As used herein, the terms “haze” and “clarity” may refer to an optical phenomenon associated with the transmission of light through a material, and may be attributed, for example, to the refraction of light within the material, e.g., due to secondary phases or porosity and/or the reflection of light from one or more surfaces of the material. As will be appreciated, haze may be associated with an amount of light that is subject to wide angle scattering (i.e., at an angle greater than 2.5° from normal) and a corresponding loss of transmissive contrast, whereas clarity may relate to an amount of light that is subject to narrow angle scattering (i.e., at an angle less than 2.5° from normal) and an attendant loss of optical sharpness or “see through quality.”

An optical element such as a waveguide may include a grating disposed over an OSC substrate. The grating may include a plurality of raised structures and may constitute a surface relief grating, for example. Example gratings may be configured with a polar angle (q) and an azimuthal angle (j), where 0≤θ≤π and φ (0≤φ≤π). The substrate may include an OSC material with either a fixed optical axis or a spatially varying optical axis.

As used herein, a grating is an optical element having a periodic structure that is configured to disperse or diffract light into plural component beams. The direction or diffraction angles of the diffracted light may depend on the wavelength of the light incident on the grating, the orientation of the incident light with respect to a grating surface, and the spacing between adjacent diffracting elements. In certain embodiments, grating architectures may be tunable along one, two, or three dimensions.

A grating may overlie a substrate through which an electromagnetic wave may propagate. According to various embodiments, the substrate includes or is formed from an organic solid crystal material. The OSC material may be single crystal or polycrystalline, and may include an amorphous organic phase. In some examples, the substrate may include a single phase OSC material. In some examples, the substrate may include a single organic solid crystal layer or an OSC multilayer. Each OSC layer may be characterized by three principal refractive indices, where n₁≠n₂≠n₃, n₁=n₂≠n₃, or n₁≠n₂=n₃. The characteristic refractive indices (n₁, n₂, n₃) may be aligned or askew with respect to the principal dimensions of the substrate.

An optical element may be formed by depositing a blanket layer of an organic solid crystal over the substrate followed by photolithography and etching to define the raised structures. In alternate embodiments, individual raised structures may be formed separately and then laminated to the substrate. Such structures may be sized and dimensioned to define a 1D or 2D periodic or non-periodic grating.

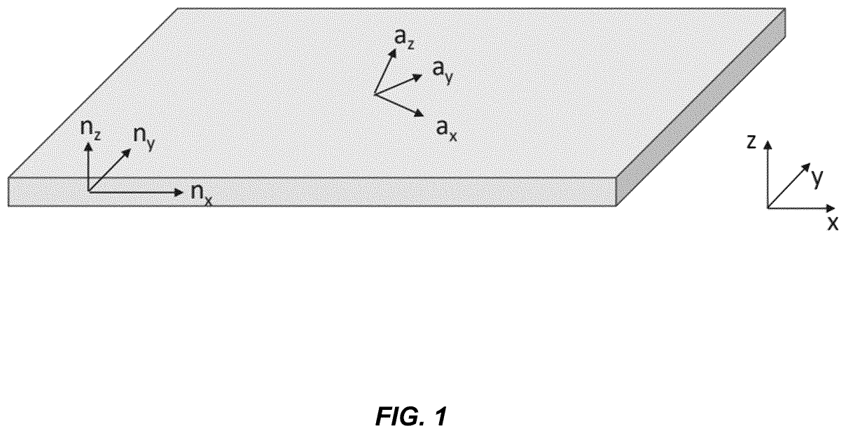

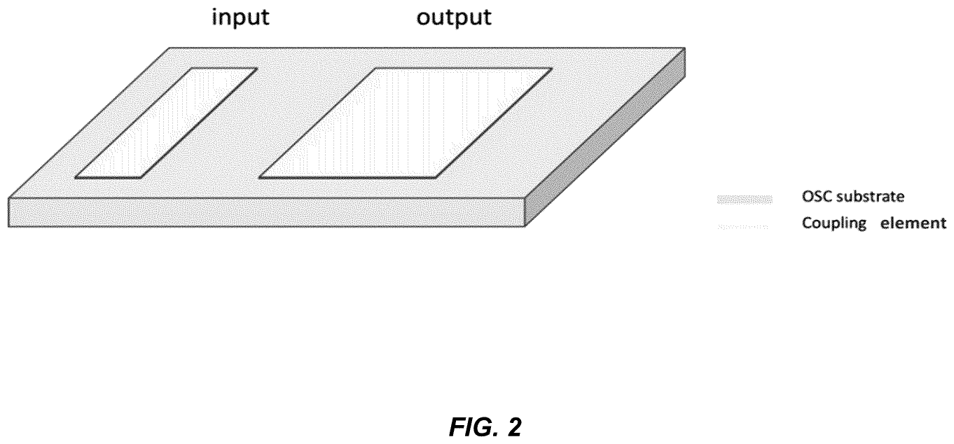

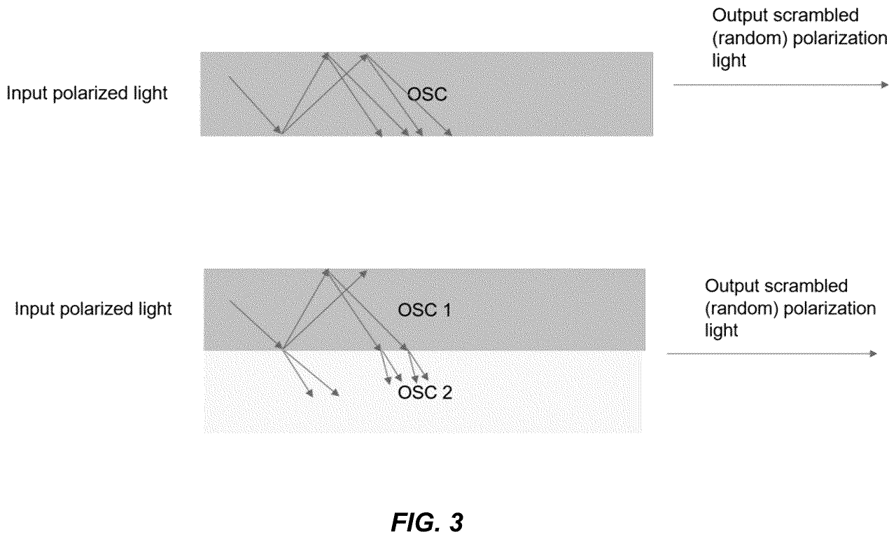

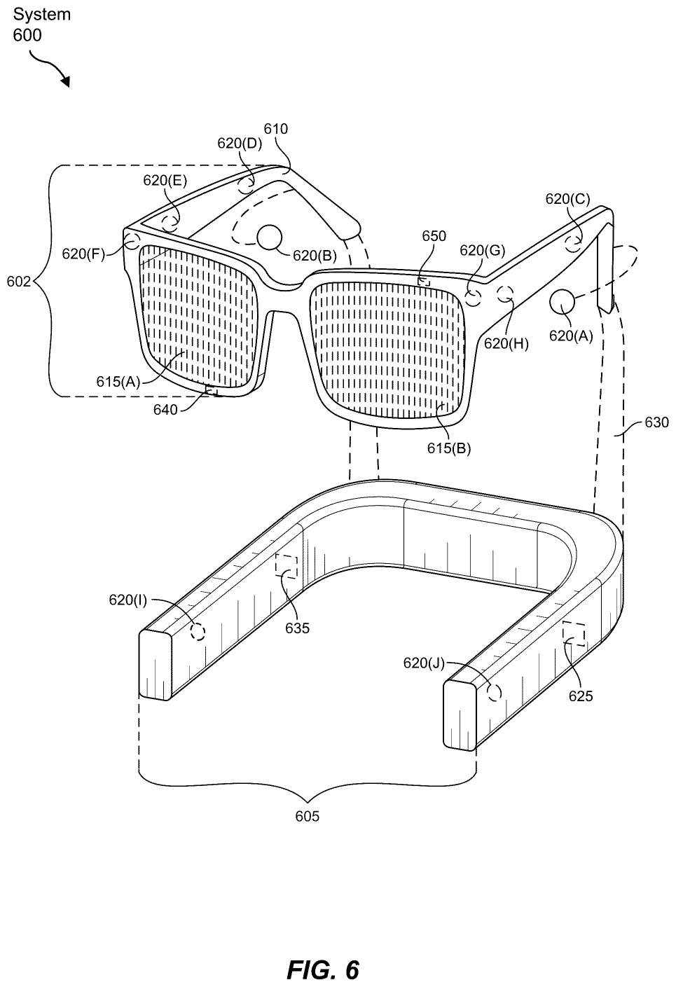

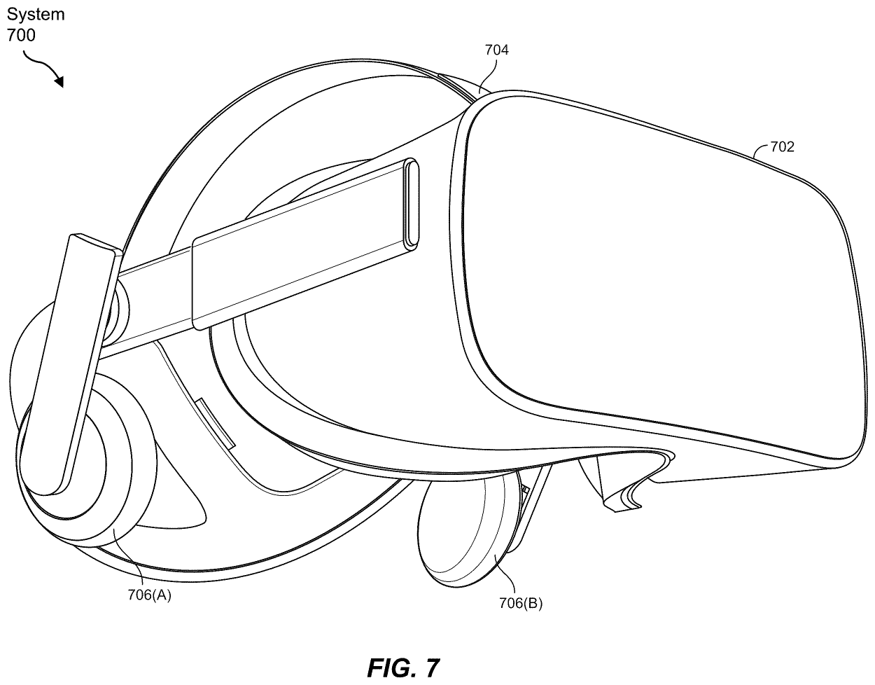

The following will provide, with reference to FIGS. 1-7, detailed descriptions of devices and related methods associated with the manufacture and operation of an organic solid crystal (OSC)-based waveguide. The discussion associated with FIGS. 1 and 2 includes a description of an OSC substrate and a diffractive waveguide including such a substrate. The discussion associated with FIGS. 3-5 includes a description of waveguide configurations including an organic solid crystal configured for polarization scrambling. The discussion associated with FIGS. 6 and 7 relates to exemplary virtual reality and augmented reality devices that may include one or more OSC-based diffractive waveguides as disclosed herein.

Referring to FIG. 1, shown is an isometric view of an OSC substrate including an optically anisotropic material such as an organic solid crystal, which may be characterized by its principal refractive indices (nₓ, n_{y}, n_{z}) and its principal symmetry axes (aₓ, a_{y}, a_{z}) relative to a reference coordinate (x, y, z). The substrate may form a waveguide body and may include an OSC material having either fixed optical axes or spatially varying optical axes. Moreover, the optical axes of the OSC material may be aligned with or at an arbitrary orientation with respect to the substrate geometry. A waveguide formed using such a substrate may additionally include one or more coupling elements overlying the substrate. Turning to FIG. 2, coupling elements (e.g., an in-coupling element and an out-coupling element) can be either diffractive or refractive, and can be formed from inorganic materials, polymers, liquid crystals, organic solid crystals, etc.

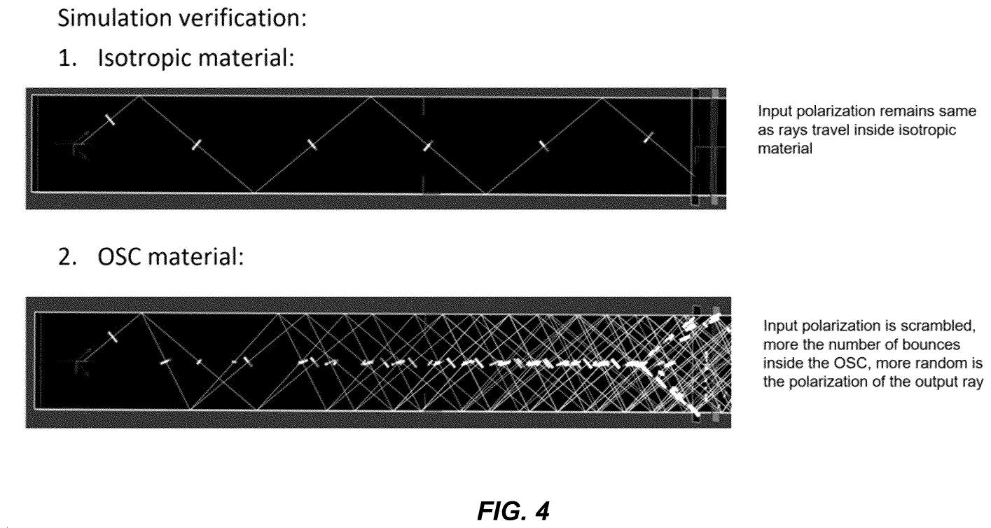

Referring to FIG. 3, illustrated is the phenomenon of polarization scrambling within an OSC waveguide. The waveguide body may include a single OSC layer or multiple OSC layers. Polarized light propagates within the waveguide body by total internal reflection. With each reflection event, the incident ray may be split into a pair of rays having mutually orthogonal polarization states. Following plural such events, the totality of the propagating rays constitute light that is randomly polarized. Modeled polarization scrambling data is shown in FIG. 4 for an isotropic material and for an anisotropic (OSC) material.

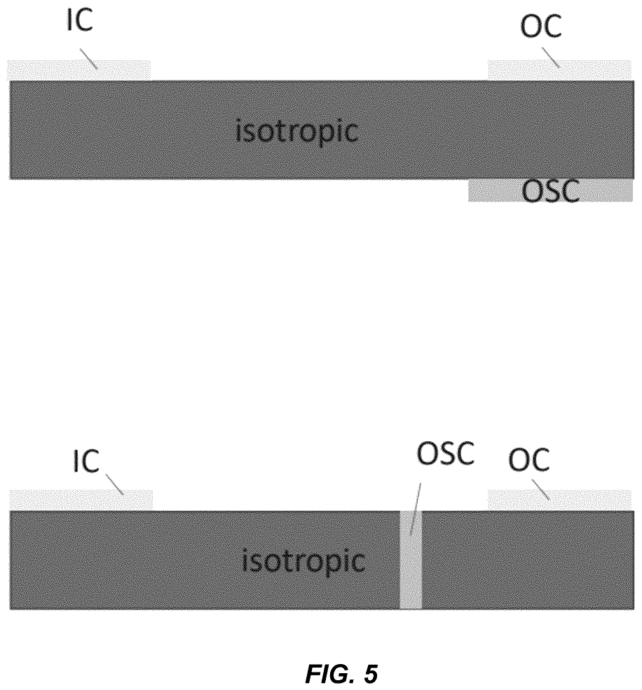

Turning to FIG. 5, shown are alternate waveguide configurations that include an OSC layer. In the embodiments of FIG. 5, the waveguide body may be formed from an optically isotropic medium. An in-coupling element (IC) and an out-coupling element (OC) may overlie the waveguide body. An embedded or otherwise co-integrated layer of an organic solid crystal may introduce interfaces that contribute to the bifurcation of propagating rays and the formation of randomly polarized light.

Disclosed are large field-of-view waveguides that include organic solid crystals (OSCs). The disclosed waveguides are advantageously low weight and exhibit a relatively slim form factor. Also disclosed are display devices and systems that include such waveguides. A display system may include a projector, an optical configuration configured to receive light from the projector and direct the received light to a waveguide, where the waveguide is configured to receive the light from the optical configuration and direct the light to a viewing location. Light incident upon the waveguide may be linearly polarized, circularly polarized, elliptically polarized, etc. The waveguide may include a substrate formed from an organic or organo-metallic material (e.g., a birefringent OSC) and a plurality of gratings disposed over and in contact with at least one surface of the substrate. Through one or more interactions with an OSC interface, the polarization of light propagating through the waveguide may be homogenized.

### Example Embodiments

Example 1: An optical element includes a waveguide body extending from an input end to an output end and configured to guide light by total internal reflection from the input end to the output end, an input coupling element located proximate to the input end for coupling polarized light into the waveguide body, and an output coupling element located proximate to the output end for coupling light having randomized polarization out of the waveguide body, wherein the waveguide body comprises an organic solid crystal configured to vary the polarization of light propagating within the waveguide body.

Example 2: The optical element of Example 1, where the input coupling structure and the output coupling structure each include a plurality of diffractive gratings.

Example 3: The optical element of any of Examples 1 and 2, where the organic solid crystal is a single crystal.

Example 4: The optical element of any of Examples 1-3, where the organic solid crystal is optically anisotropic.

Example 5: The optical element of any of Examples 1-4, where the organic solid crystal has a minimum refractive index of at least approximately 1.5 and a birefringence of at least approximately 0.01.

Example 6: The optical element of any of Examples 1-5, where the waveguide body includes principal refractive indices (n₁, n₂, n₃), where n₁≠n₂≠n₃, n₁=n₂≠n₃, n₁=n₃≠n₂, or n₂=n₃≠n₁.

Example 7: The optical element of any of Examples 1-6, where the waveguide body includes a single optically anisotropic organic solid crystal layer having a thickness of less than approximately 600 micrometers.

Example 8: The optical element of any of Examples 1-6, where the waveguide body includes a pair of independently oriented optically anisotropic organic solid crystal layers and has a thickness of less than approximately 1.5 mm.

Example 9: The optical element of any of Examples 1-6, where the waveguide body includes three independently oriented optically anisotropic organic solid crystal layers and has a thickness of less than approximately 1.8 mm.

Example 10: A waveguide includes an optically anisotropic organic solid crystal substrate configured to guide and randomize the polarization of light therethrough.

Embodiments of the present disclosure may include or be implemented in conjunction with various types of artificial-reality systems. Artificial reality is a form of reality that has been adjusted in some manner before presentation to a user, which may include, for example, a virtual reality, an augmented reality, a mixed reality, a hybrid reality, or some combination and/or derivative thereof. Artificial-reality content may include completely computer-generated content or computer-generated content combined with captured (e.g., real-world) content. The artificial-reality content may include video, audio, haptic feedback, or some combination thereof, any of which may be presented in a single channel or in multiple channels (such as stereo video that produces a three-dimensional (3D) effect to the viewer). Additionally, in some embodiments, artificial reality may also be associated with applications, products, accessories, services, or some combination thereof, that are used to, for example, create content in an artificial reality and/or are otherwise used in (e.g., to perform activities in) an artificial reality.

Artificial-reality systems may be implemented in a variety of different form factors and configurations. Some artificial-reality systems may be designed to work without near-eye displays (NEDs). Other artificial-reality systems may include an NED that also provides visibility into the real world (e.g., augmented-reality system 600 in FIG. 6) or that visually immerses a user in an artificial reality (e.g., virtual-reality system 700 in FIG. 7). While some artificial-reality devices may be self-contained systems, other artificial-reality devices may communicate and/or coordinate with external devices to provide an artificial-reality experience to a user. Examples of such external devices include handheld controllers, mobile devices, desktop computers, devices worn by a user, devices worn by one or more other users, and/or any other suitable external system.

Turning to FIG. 6, augmented-reality system 600 may include an eyewear device 602 with a frame 610 configured to hold a left display device 615(A) and a right display device 615(B) in front of a user's eyes. Display devices 615(A) and 615(B) may act together or independently to present an image or series of images to a user. While augmented-reality system 600 includes two displays, embodiments of this disclosure may be implemented in augmented-reality systems with a single NED or more than two NEDs.

In some embodiments, augmented-reality system 600 may include one or more sensors, such as sensor 640. Sensor 640 may generate measurement signals in response to motion of augmented-reality system 600 and may be located on substantially any portion of frame 610. Sensor 640 may represent a position sensor, an inertial measurement unit (IMU), a depth camera assembly, a structured light emitter and/or detector, or any combination thereof. In some embodiments, augmented-reality system 600 may or may not include sensor 640 or may include more than one sensor. In embodiments in which sensor 640 includes an IMU, the IMU may generate calibration data based on measurement signals from sensor 640. Examples of sensor 640 may include, without limitation, accelerometers, gyroscopes, magnetometers, other suitable types of sensors that detect motion, sensors used for error correction of the IMU, or some combination thereof.

Augmented-reality system 600 may also include a microphone array with a plurality of acoustic transducers 620(A)-620(J), referred to collectively as acoustic transducers 620. Acoustic transducers 620 may be transducers that detect air pressure variations induced by sound waves. Each acoustic transducer 620 may be configured to detect sound and convert the detected sound into an electronic format (e.g., an analog or digital format). The microphone array in FIG. 6 may include, for example, ten acoustic transducers: 620(A) and 620(B), which may be designed to be placed inside a corresponding ear of the user, acoustic transducers 620(C), 620(D), 620(E), 620(F), 620(G), and 620(H), which may be positioned at various locations on frame 610, and/or acoustic transducers 620(I) and 620(J), which may be positioned on a corresponding neckband 605.

In some embodiments, one or more of acoustic transducers 620(A)-(F) may be used as output transducers (e.g., speakers). For example, acoustic transducers 620(A) and/or 620(B) may be earbuds or any other suitable type of headphone or speaker.

The configuration of acoustic transducers 620 of the microphone array may vary. While augmented-reality system 600 is shown in FIG. 6 as having ten acoustic transducers 620, the number of acoustic transducers 620 may be greater or less than ten. In some embodiments, using higher numbers of acoustic transducers 620 may increase the amount of audio information collected and/or the sensitivity and accuracy of the audio information. In contrast, using a lower number of acoustic transducers 620 may decrease the computing power required by an associated controller 650 to process the collected audio information. In addition, the position of each acoustic transducer 620 of the microphone array may vary. For example, the position of an acoustic transducer 620 may include a defined position on the user, a defined coordinate on frame 610, an orientation associated with each acoustic transducer 620, or some combination thereof.

Acoustic transducers 620(A) and 620(B) may be positioned on different parts of the user's ear, such as behind the pinna, behind the tragus, and/or within the auricle or fossa. Or, there may be additional acoustic transducers 620 on or surrounding the ear in addition to acoustic transducers 620 inside the ear canal. Having an acoustic transducer 620 positioned next to an ear canal of a user may enable the microphone array to collect information on how sounds arrive at the ear canal. By positioning at least two of acoustic transducers 620 on either side of a user's head (e.g., as binaural microphones), augmented-reality device 600 may simulate binaural hearing and capture a 3D stereo sound field around about a user's head. In some embodiments, acoustic transducers 620(A) and 620(B) may be connected to augmented-reality system 600 via a wired connection 630, and in other embodiments acoustic transducers 620(A) and 620(B) may be connected to augmented-reality system 600 via a wireless connection (e.g., a Bluetooth connection). In still other embodiments, acoustic transducers 620(A) and 620(B) may not be used at all in conjunction with augmented-reality system 600.

Acoustic transducers 620 on frame 610 may be positioned along the length of the temples, across the bridge, above or below display devices 615(A) and 615(B), or some combination thereof. Acoustic transducers 620 may be oriented such that the microphone array is able to detect sounds in a wide range of directions surrounding the user wearing the augmented-reality system 600. In some embodiments, an optimization process may be performed during manufacturing of augmented-reality system 600 to determine relative positioning of each acoustic transducer 620 in the microphone array.

In some examples, augmented-reality system 600 may include or be connected to an external device (e.g., a paired device), such as neckband 605. Neckband 605 generally represents any type or form of paired device. Thus, the following discussion of neckband 605 may also apply to various other paired devices, such as charging cases, smart watches, smart phones, wrist bands, other wearable devices, hand-held controllers, tablet computers, laptop computers, other external compute devices, etc.

As shown, neckband 605 may be coupled to eyewear device 602 via one or more connectors. The connectors may be wired or wireless and may include electrical and/or non-electrical (e.g., structural) components. In some cases, eyewear device 602 and neckband 605 may operate independently without any wired or wireless connection between them. While FIG. 6 illustrates the components of eyewear device 602 and neckband 605 in example locations on eyewear device 602 and neckband 605, the components may be located elsewhere and/or distributed differently on eyewear device 602 and/or neckband 605. In some embodiments, the components of eyewear device 602 and neckband 605 may be located on one or more additional peripheral devices paired with eyewear device 602, neckband 605, or some combination thereof.

Pairing external devices, such as neckband 605, with augmented-reality eyewear devices may enable the eyewear devices to achieve the form factor of a pair of glasses while still providing sufficient battery and computation power for expanded capabilities. Some or all of the battery power, computational resources, and/or additional features of augmented-reality system 600 may be provided by a paired device or shared between a paired device and an eyewear device, thus reducing the weight, heat profile, and form factor of the eyewear device overall while still retaining desired functionality. For example, neckband 605 may allow components that would otherwise be included on an eyewear device to be included in neckband 605 since users may tolerate a heavier weight load on their shoulders than they would tolerate on their heads. Neckband 605 may also have a larger surface area over which to diffuse and disperse heat to the ambient environment. Thus, neckband 605 may allow for greater battery and computation capacity than might otherwise have been possible on a stand-alone eyewear device. Since weight carried in neckband 605 may be less invasive to a user than weight carried in eyewear device 602, a user may tolerate wearing a lighter eyewear device and carrying or wearing the paired device for greater lengths of time than a user would tolerate wearing a heavy standalone eyewear device, thereby enabling users to more fully incorporate artificial-reality environments into their day-to-day activities.

Neckband 605 may be communicatively coupled with eyewear device 602 and/or to other devices. These other devices may provide certain functions (e.g., tracking, localizing, depth mapping, processing, storage, etc.) to augmented-reality system 600. In the embodiment of FIG. 6, neckband 605 may include two acoustic transducers (e.g., 620(I) and 620(J)) that are part of the microphone array (or potentially form their own microphone subarray). Neckband 605 may also include a controller 625 and a power source 635.

Acoustic transducers 620(I) and 620(J) of neckband 605 may be configured to detect sound and convert the detected sound into an electronic format (analog or digital). In the embodiment of FIG. 6, acoustic transducers 620(I) and 620(J) may be positioned on neckband 605, thereby increasing the distance between the neckband acoustic transducers 620(I) and 620(J) and other acoustic transducers 620 positioned on eyewear device 602. In some cases, increasing the distance between acoustic transducers 620 of the microphone array may improve the accuracy of beamforming performed via the microphone array. For example, if a sound is detected by acoustic transducers 620(C) and 620(D) and the distance between acoustic transducers 620(C) and 620(D) is greater than, e.g., the distance between acoustic transducers 620(D) and 620(E), the determined source location of the detected sound may be more accurate than if the sound had been detected by acoustic transducers 620(D) and 620(E).

Controller 625 of neckband 605 may process information generated by the sensors on neckband 605 and/or augmented-reality system 600. For example, controller 625 may process information from the microphone array that describes sounds detected by the microphone array. For each detected sound, controller 625 may perform a direction-of-arrival (DOA) estimation to estimate a direction from which the detected sound arrived at the microphone array. As the microphone array detects sounds, controller 625 may populate an audio data set with the information. In embodiments in which augmented-reality system 600 includes an inertial measurement unit, controller 625 may compute all inertial and spatial calculations from the IMU located on eyewear device 602. A connector may convey information between augmented-reality system 600 and neckband 605 and between augmented-reality system 600 and controller 625. The information may be in the form of optical data, electrical data, wireless data, or any other transmittable data form. Moving the processing of information generated by augmented-reality system 600 to neckband 605 may reduce weight and heat in eyewear device 602, making it more comfortable to the user.

Power source 635 in neckband 605 may provide power to eyewear device 602 and/or to neckband 605. Power source 635 may include, without limitation, lithium ion batteries, lithium-polymer batteries, primary lithium batteries, alkaline batteries, or any other form of power storage. In some cases, power source 635 may be a wired power source. Including power source 635 on neckband 605 instead of on eyewear device 602 may help better distribute the weight and heat generated by power source 635.

As noted, some artificial-reality systems may, instead of blending an artificial reality with actual reality, substantially replace one or more of a user's sensory perceptions of the real world with a virtual experience. One example of this type of system is a head-worn display system, such as virtual-reality system 700 in FIG. 7, that mostly or completely covers a user's field of view. Virtual-reality system 700 may include a front rigid body 702 and a band 704 shaped to fit around a user's head. Virtual-reality system 700 may also include output audio transducers 706(A) and 706(B). Furthermore, while not shown in FIG. 7, front rigid body 702 may include one or more electronic elements, including one or more electronic displays, one or more inertial measurement units (IMUs), one or more tracking emitters or detectors, and/or any other suitable device or system for creating an artificial reality experience.

Artificial-reality systems may include a variety of types of visual feedback mechanisms. For example, display devices in augmented-reality system 600 and/or virtual-reality system 700 may include one or more liquid crystal displays (LCDs), light emitting diode (LED) displays, organic LED (OLED) displays, digital light project (DLP) micro-displays, liquid crystal on silicon (LCoS) micro-displays, and/or any other suitable type of display screen. Artificial-reality systems may include a single display screen for both eyes or may provide a display screen for each eye, which may allow for additional flexibility for varifocal adjustments or for correcting a user's refractive error. Some artificial-reality systems may also include optical subsystems having one or more lenses (e.g., conventional concave or convex lenses, Fresnel lenses, adjustable liquid lenses, etc.) through which a user may view a display screen. These optical subsystems may serve a variety of purposes, including to collimate (e.g., make an object appear at a greater distance than its physical distance), to magnify (e.g., make an object appear larger than its actual size), and/or to relay (to, e.g., the viewer's eyes) light. These optical subsystems may be used in a non-pupil-forming architecture (such as a single lens configuration that directly collimates light but results in so-called pincushion distortion) and/or a pupil-forming architecture (such as a multi-lens configuration that produces so-called barrel distortion to nullify pincushion distortion).

In addition to or instead of using display screens, some artificial-reality systems may include one or more projection systems. For example, display devices in augmented-reality system 600 and/or virtual-reality system 700 may include micro-LED projectors that project light (using, e.g., a waveguide) into display devices, such as clear combiner lenses that allow ambient light to pass through. The display devices may refract the projected light toward a user's pupil and may enable a user to simultaneously view both artificial-reality content and the real world. The display devices may accomplish this using any of a variety of different optical components, including waveguide components (e.g., holographic, planar, diffractive, polarized, and/or reflective waveguide elements), light-manipulation surfaces and elements (such as diffractive, reflective, and refractive elements and gratings), coupling elements, etc. Artificial-reality systems may also be configured with any other suitable type or form of image projection system, such as retinal projectors used in virtual retina displays.

Artificial-reality systems may also include various types of computer vision components and subsystems. For example, augmented-reality system 600 and/or virtual-reality system 700 may include one or more optical sensors, such as two-dimensional (2D) or 3D cameras, structured light transmitters and detectors, time-of-flight depth sensors, single-beam or sweeping laser rangefinders, 3D LiDAR sensors, and/or any other suitable type or form of optical sensor. An artificial-reality system may process data from one or more of these sensors to identify a location of a user, to map the real world, to provide a user with context about real-world surroundings, and/or to perform a variety of other functions.

Artificial-reality systems may also include one or more input and/or output audio transducers. In the examples shown in FIG. 7, output audio transducers 706(A) and 706(B) may include voice coil speakers, ribbon speakers, electrostatic speakers, piezoelectric speakers, bone conduction transducers, cartilage conduction transducers, tragus-vibration transducers, and/or any other suitable type or form of audio transducer. Similarly, input audio transducers may include condenser microphones, dynamic microphones, ribbon microphones, and/or any other type or form of input transducer. In some embodiments, a single transducer may be used for both audio input and audio output.

While not shown in FIG. 6, artificial-reality systems may include tactile (i.e., haptic) feedback systems, which may be incorporated into headwear, gloves, body suits, handheld controllers, environmental devices (e.g., chairs, floormats, etc.), and/or any other type of device or system. Haptic feedback systems may provide various types of cutaneous feedback, including vibration, force, traction, texture, and/or temperature. Haptic feedback systems may also provide various types of kinesthetic feedback, such as motion and compliance. Haptic feedback may be implemented using motors, piezoelectric actuators, fluidic systems, and/or a variety of other types of feedback mechanisms. Haptic feedback systems may be implemented independent of other artificial-reality devices, within other artificial-reality devices, and/or in conjunction with other artificial-reality devices.

By providing haptic sensations, audible content, and/or visual content, artificial-reality systems may create an entire virtual experience or enhance a user's real-world experience in a variety of contexts and environments. For instance, artificial-reality systems may assist or extend a user's perception, memory, or cognition within a particular environment. Some systems may enhance a user's interactions with other people in the real world or may enable more immersive interactions with other people in a virtual world. Artificial-reality systems may also be used for educational purposes (e.g., for teaching or training in schools, hospitals, government organizations, military organizations, business enterprises, etc.), entertainment purposes (e.g., for playing video games, listening to music, watching video content, etc.), and/or for accessibility purposes (e.g., as hearing aids, visual aids, etc.). The embodiments disclosed herein may enable or enhance a user's artificial-reality experience in one or more of these contexts and environments and/or in other contexts and environments.

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the present disclosure. The embodiments disclosed herein should be considered in all respects illustrative and not restrictive. Reference should be made to the appended claims and their equivalents in determining the scope of the present disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

It will be understood that when an element such as a layer or a region is referred to as being formed on, deposited on, or disposed “on” or “over” another element, it may be located directly on at least a portion of the other element, or one or more intervening elements may also be present. In contrast, when an element is referred to as being “directly on” or “directly over” another element, it may be located on at least a portion of the other element, with no intervening elements present.

As used herein, the term “approximately” in reference to a particular numeric value or range of values may, in certain embodiments, mean and include the stated value as well as all values within 10% of the stated value. Thus, by way of example, reference to the numeric value “50” as “approximately 50” may, in certain embodiments, include values equal to 50±5, i.e., values within the range 45 to 55.

As used herein, the term “substantially” in reference to a given parameter, property, or condition may mean and include to a degree that one of ordinary skill in the art would understand that the given parameter, property, or condition is met with a small degree of variance, such as within acceptable manufacturing tolerances. By way of example, depending on the particular parameter, property, or condition that is substantially met, the parameter, property, or condition may be at least approximately 90% met, at least approximately 95% met, or even at least approximately 99% met.

While various features, elements or steps of particular embodiments may be disclosed using the transitional phrase “comprising,” it is to be understood that alternative embodiments, including those that may be described using the transitional phrases “consisting of” or “consisting essentially of,” are implied. Thus, for example, implied alternative embodiments to an organic solid crystal layer that comprises or includes anthracene include embodiments where an organic solid crystal layer consists essentially of anthracene and embodiments where an organic solid crystal layer consists of anthracene.

Waveguide Display with Outcoupling Grating and Reflective Array

A waveguide display system may include a micro-display module and waveguide optics for directing a display image to a user. The micro-display module may include a light source, such as a light emitting diode (LED). The waveguide optics may include input-coupling and output-coupling elements such as surface relief gratings that are configured to couple light into and out of the waveguide. Example grating structures may have a two-dimensional periodicity. In some embodiments, a vertical grating coupler, for instance, may be configured to change an out-of-plane wave-vector direction of light to an in-plane waveguide direction, or vice versa, and accordingly direct the passage of light through the waveguide display.

In exemplary systems, the waveguide optics may be advantageously configured to create illuminance uniformity and a wide field of view (FOV). The FOV relates to the angular range of an image observable by a user, whereas illuminance uniformity may include both the uniformity of image light over an expanded exit pupil (exit pupil uniformity) and the uniformity of image light over the FOV (angular uniformity). As will be appreciated, an input-coupling grating may determine the angular uniformity and coupling efficiency of image light.

Notwithstanding recent developments, it would be beneficial to develop performance-enhancing waveguide optics, and particularly input-coupling and output-coupling elements that are economical to manufacture while exhibiting improved design flexibility and functionality. In accordance with various embodiments, a waveguide display system includes an array of discrete output-coupling elements that are co-integrated with reflective layers that are configured to inhibit the loss of image light. A reflective layer may be disposed over each respective output-coupling element. The reflective layers may be adapted to redirect image light decoupled from the waveguide in the direction of the world side of the display system back to the eye of a user.

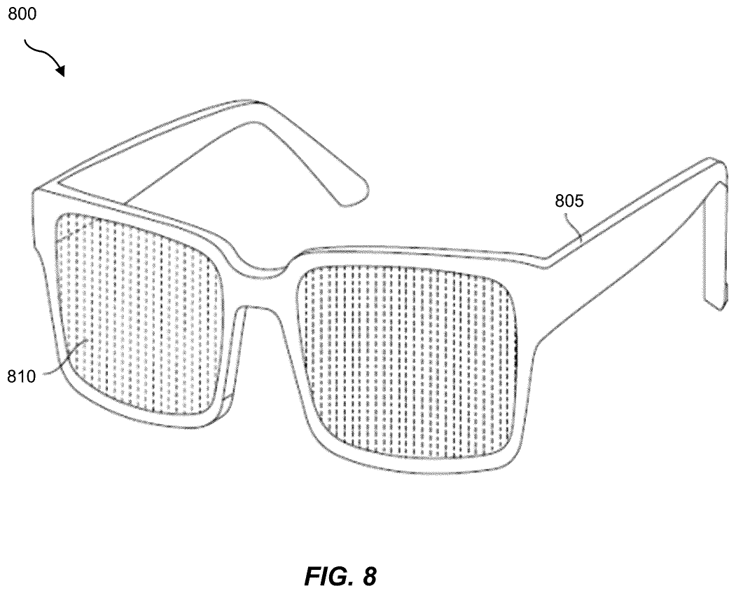

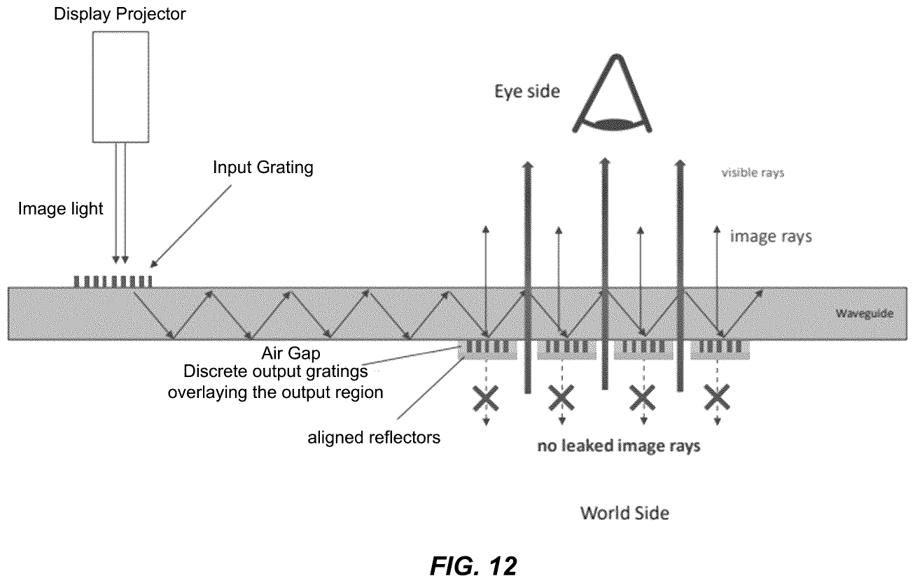

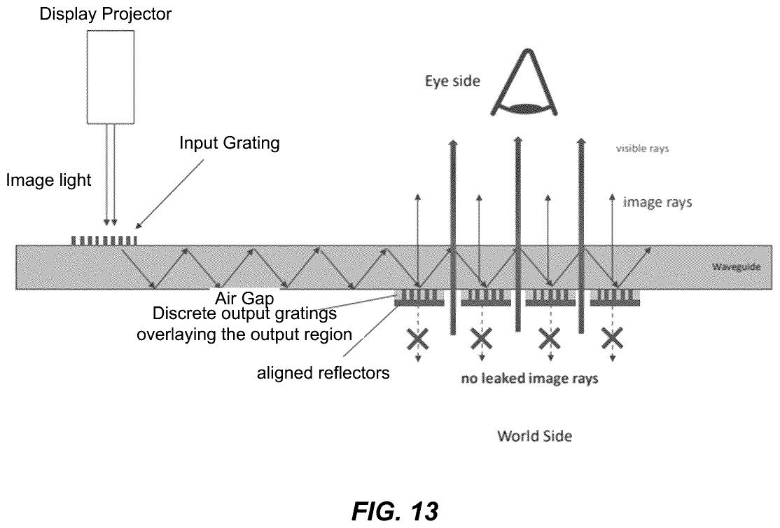

The following will provide, with reference to FIGS. 8-13, detailed descriptions of devices and related methods associated with a waveguide display having decreased light loss. The discussion associated with FIGS. 8-11 relates to an example near-eye display (NED). The discussion associated with FIGS. 12 and 13 relates to various waveguide display architectures.

FIG. 8 is a diagram of a near-eye-display (NED), in accordance with some embodiments. The NED 800 may present media to a user. Examples of media that may be presented by the NED 800 include one or more images, video, audio, or some combination thereof. In some embodiments, audio may be presented via an external device (e.g., speakers and/or headphones) that receives audio information from the NED 800, a console (not shown), or both, and presents audio data to the user based on the audio information. The NED 800 is generally configured to operate as an augmented reality (AR) NED. However, in some embodiments, the NED 800 may be modified to also operate as a virtual reality (VR) NED, a mixed reality (MR) NED, or some combination thereof. By way of example, in some embodiments, the NED 800 may augment views of a physical, real-world environment with computer-generated elements (e.g., still images, video, sound, etc.).

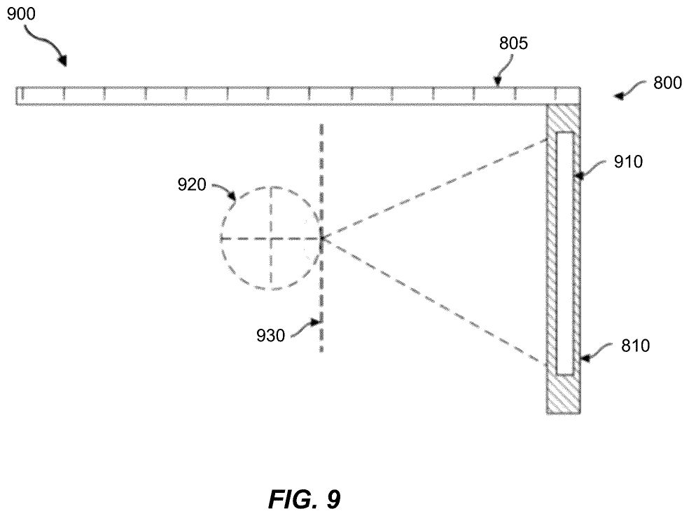

The NED 800 shown in FIG. 8 may include a frame 805 and a display 810. The frame 805 may include one or more optical elements that together display media to a user. That is, the display 810 may be configured for a user to view the content presented by the NED 800. As discussed below in conjunction with FIG. 9, the display 810 may include at least one source assembly to generate image light to present optical media to an eye of the user. The source assembly may include, e.g., a source, an optics system, or some combination thereof.

It will be appreciated that FIG. 8 is merely an example of an augmented reality system, and the display systems described herein may be incorporated into further such systems. In some embodiments, FIG. 8 may also be referred to as a head-mounted display (HMD).

FIG. 9 is a cross section 900 of the NED 800 illustrated in FIG. 8, in accordance with some embodiments of the present disclosure. The cross section 900 may include at least one display assembly 910 and an exit pupil 930. The exit pupil 930 is a location where the eye 920 may be positioned when a user wears the NED 800. In some embodiments, the frame 805 may represent a frame of eyewear glasses. For purposes of illustration, FIG. 9 shows the cross section 900 associated with a single eye 920 and a single display assembly 910, but in alternative embodiments not shown, another display assembly that is separate from or integrated with the display assembly 910 shown in FIG. 9, may provide image light to another eye of the user.

The display assembly 910 may be configured to direct image light to the eye 920 through the exit pupil 930. The display assembly 910 may be composed of one or more materials (e.g., plastic, glass, etc.) with one or more refractive indices that effectively decrease the weight and widen a field of view of the NED 800.

In alternate configurations, the NED 800 may include one or more optical elements (not shown) located between the display assembly 910 and the eye 920. The optical elements may act to, by way of various examples, correct aberrations in image light emitted from the display assembly 910, magnify image light emitted from the display assembly 910, perform some other optical adjustment of image light emitted from the display assembly 910, or combinations thereof. Example optical elements may include an aperture, a Fresnel lens, a convex lens, a concave lens, a filter, a polarizer, or any other suitable optical element that may affect image light.

In some embodiments, the display assembly 910 may include a source assembly to generate image light to present media to a user's eyes. The source assembly may include, e.g., a light source, an optics system, or some combination thereof. In accordance with various embodiments, a source assembly may include a light-emitting diode (LED) such as an organic light-emitting diode (OLED).

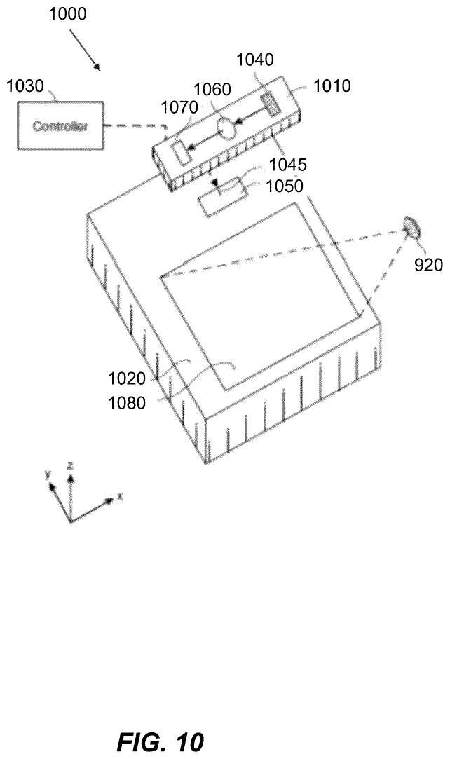

FIG. 10 illustrates an isometric view of a waveguide display in accordance with some embodiments. The waveguide display 1000 may be a component (e.g., display assembly 910) of NED 800. In alternate embodiments, the waveguide display 1000 may constitute a part of some other NED, or other system that directs display image light to a particular location.

The waveguide display 1000 may include a source assembly 1010, an output waveguide 1020, and a controller 1030. For purposes of illustration, FIG. 10 shows the waveguide display 1000 associated with a single eye 920, but in some embodiments, another waveguide display separate (or partially separate) from the waveguide display 1000 may provide image light to another eye of the user. In a partially separate system, one or more components may be shared between waveguide displays for each eye.

The source assembly 1010 generates image light. The source assembly 1010 may include a source 1040, a light conditioning assembly 1060, and a scanning mirror assembly 1070. The source assembly 1010 may generate and output image light 1045 to a coupling element 1050 of the output waveguide 1020. Image light may include linearly polarized light, for example.

The source 1040 may include a source of light that generates coherent or partially coherent image light 1045. The source 1040 may emit light in accordance with one or more illumination parameters received from the controller 1030. The source 1040 may include one or more source elements, including, but not restricted to light emitting diodes, such as micro-OLEDs.

The output waveguide 1020 may be configured as an optical waveguide that outputs image light to an eye 920 of a user. The output waveguide 1020 receives the image light 1045 through one or more coupling elements 1050 and guides the received input image light 1045 to one or more decoupling elements 1080. In some embodiments, the coupling element 1050 couples the image light 1045 from the source assembly 1010 into the output waveguide 1020. The coupling element 1050 may be or include a diffraction grating, a holographic grating, some other element that couples the image light 1045 into the output waveguide 1020, or some combination thereof. For example, in embodiments where the coupling element 1050 is a diffraction grating, the pitch of the diffraction grating may be chosen such that total internal reflection occurs, and the image light 1045 propagates internally toward the decoupling element 1080. For example, the pitch of the diffraction grating may be in the range of approximately 1000 nm to approximately 600 nm.

The decoupling element 1080 decouples the total internally reflected image light from the output waveguide 1020. The decoupling element 1080 may be or include a diffraction grating, a holographic grating, some other element that decouples image light out of the output waveguide 1020, or some combination thereof. For example, in embodiments where the decoupling element 1080 is a diffraction grating, the pitch of the diffraction grating may be chosen to cause incident image light to exit the output waveguide 1020. An orientation and position of the image light exiting from the output waveguide 1020 may be controlled by changing an orientation and position of the image light 1045 entering the coupling element 1050.

The output waveguide 1020 may be composed of one or more materials that facilitate total internal reflection of the image light 1045. The output waveguide 1020 may be composed of, for example, silicon, glass, or a polymer, or some combination thereof. The output waveguide 1020 may have a relatively small form factor such as for use in a head-mounted display. For example, the output waveguide 1020 may be approximately 30 mm wide along an x-dimension, 50 mm long along a y-dimension, and 0.5-1 mm thick along a z-dimension. In some embodiments, the output waveguide 1020 may be a planar (2D) optical waveguide.

The controller 1030 may be used to control the scanning operations of the source assembly 1010. In certain embodiments, the controller 1030 may determine scanning instructions for the source assembly 1010 based at least on one or more display instructions. Display instructions may include instructions to render one or more images. In some embodiments, display instructions may include an image file (e.g., bitmap). The display instructions may be received from, e.g., a console of a virtual reality system (not shown). Scanning instructions may include instructions used by the source assembly 1010 to generate image light 1045. The scanning instructions may include, e.g., a type of a source of image light (e.g., monochromatic, polychromatic), a scanning rate, an orientation of scanning mirror assembly 1070, and/or one or more illumination parameters, etc. The controller 1030 may include a combination of hardware, software, and/or firmware not shown here so as not to obscure other aspects of the disclosure.

According to some embodiments, source 1040 may include a light emitting diode (LED), such as an organic light emitting diode (OLED). An organic light-emitting diode (OLED) is a light-emitting diode (LED) having an emissive electroluminescent layer that may include a thin film of an organic compound that emits light in response to an electric current. The organic layer is typically situated between a pair of conductive electrodes. One or both of the electrodes may be optically transparent.

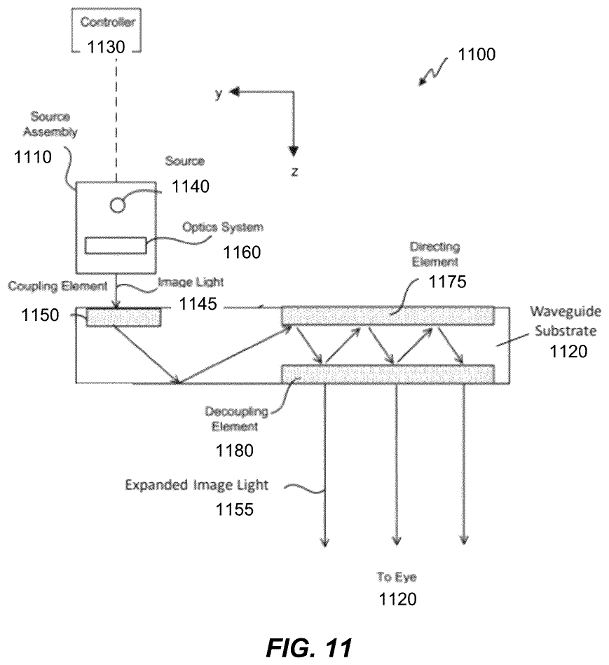

FIG. 11 illustrates an embodiment of a cross section of a waveguide display. The waveguide display 1100 includes a source assembly 1110 configured to generate image light 1145 in accordance with scanning instructions from controller 1130. The source assembly 1110 includes a source 1140 and an optics system 1160. The source 1140 may be a light source that generates coherent or partially coherent light. The source 1140 may include, e.g., a laser diode, a vertical cavity surface emitting laser, and/or a light emitting diode.

The optics system 1160 may include one or more optical components configured to condition the light from the source 1140. Conditioning light from the source 1140 may include, e.g., expanding, collimating, and/or adjusting orientation in accordance with instructions from the controller 1130. The one or more optical components may include one or more of a lens, liquid lens, mirror, aperture, and/or grating. In some embodiments, the optics system 1160 includes a liquid lens with a plurality of electrodes that allows scanning a beam of light with a threshold value of scanning angle to shift the beam of light to a region outside the liquid lens. Light emitted from the optics system 1160 (and also the source assembly 1110) is referred to as image light 1145.

The output waveguide 1120 receives the image light 1145. Coupling element 1150 couples the image light 1145 from the source assembly 1110 into the output waveguide 1120. In embodiments where the coupling element 1150 is a diffraction grating, a pitch of the diffraction grating may be chosen such that total internal reflection occurs in the output waveguide 1120, and the image light 1145 propagates internally in the output waveguide 1120 (e.g., by total internal reflection) toward decoupling element 1180.

A directing element 1175 may be configured to redirect the image light 1145 toward the decoupling element 1180 for decoupling from the output waveguide 1120. In embodiments where the directing element 1175 is a diffraction grating, the pitch of the diffraction grating may be chosen to cause incident image light 1145 to exit the output waveguide 1120 at angle(s) of inclination relative to a surface of the decoupling element 1180.

In some embodiments, the directing element 1175 and/or the decoupling element 1180 may be structurally similar. The expanded image light 1155 exiting the output waveguide 1120 may be expanded along one or more dimensions (e.g., may be elongated along an x-dimension).

In some embodiments, the waveguide display 1100 may include a plurality of source assemblies 1110 and a plurality of output waveguides 1120. Each of the source assemblies 1110 may be configured to emit monochromatic image light of a specific band of wavelength corresponding to a primary color (e.g., red, yellow, or blue). Each of the output waveguides 1120 may be stacked together with a distance of separation to output expanded image light 1155 that is multi-colored.

Referring to FIG. 12, shown is a cross-sectional view of a further waveguide display. The display includes a source of image light and waveguide optics for expanding and directing the image light to the eye of a user. The image light is coupled into the waveguide through an input grating and, following one or more reflections within the waveguide, coupled out of the waveguide through an output grating array and directed to the eye of a user.

In the illustrated embodiment, the output grating array includes a plurality of discrete and spaced apart output gratings for decoupling the light and a reflector overlying each respective output grating for redirecting light decoupled to the world side of the waveguide display back to the user's eye. As shown in FIG. 12, the reflector layers may be formed from a material that is different than the material used to form the individual grating elements. As shown in FIG. 13, the reflector layers and the grating elements may be formed from the same reflective material.

A waveguide display includes a waveguide substrate and a plurality of decoupling elements for decoupling image light from the substrate. Discrete decoupling elements may be arranged as an array within a decoupling region of the display and may include a binary or slanted grating architecture, for example. The decoupling elements may each additionally include an overlying reflective layer on the world side of the waveguide substrate. The reflective layers may be configured to inhibit the transmission of decoupled light to the world side of the display and correspondingly increase the amount of image light coupled to the eye of a user, thus significantly increasing component level diffraction efficiency. The reflective layers may include any suitable reflective material such as a metal thin film. For augmented reality applications, gaps between the decoupling elements within the decoupling region may be filled with an optically transparent material that allows real world light to reach the user's eye.

### Example Embodiments

Example 1: A display includes a waveguide, a plurality of decoupling elements disposed over a surface of the waveguide, and a reflective element disposed over each respective decoupling element.

Example 2: The display of Example 8, where the plurality of decoupling elements constitute an array disposed over the surface of the waveguide.

Example 3: The display of any of Examples 8 and 9, where the reflective elements are configured to redirect image light passing through each respective decoupling element back toward the waveguide.

### Polarization Multiplexing Display

Virtual reality (VR) and augmented reality (AR) eyewear devices and headsets enable users to experience events, such as interactions with people in a computer-generated simulation of a three-dimensional world or viewing data superimposed on a real-world view. Superimposing information onto a field of view may be achieved through an optical head-mounted display (OHMD) or by using embedded wireless glasses with a transparent heads-up display (HUD) or augmented reality overlay. VR/AR eyewear devices and headsets may be used for a variety of purposes. Governments may use such devices for military training, medical professionals may use such devices to simulate surgery, and engineers may use such devices as design visualization aids.

Virtual reality and augmented reality devices and headsets typically include an optical system having a microdisplay and imaging optics. The microdisplay may be configured to provide an image to be viewed either directly or indirectly. Display light may be generated and projected to the eyes of a user using a display system where the light may be in-coupled into a waveguide, transported therethrough by total internal reflection (TIR), replicated to form an expanded field of view, and out-coupled when reaching the position of a viewer's eye.

For AR displays, several types of light engines have been developed as the image source to provide the virtual images. Example engine platforms include digital light processors (DLPs), OLED microdisplays (μtOLEDs), micro-LEDs, laser beam scanners (LBSs), and liquid crystal on silicon (LCoS) configurations. Liquid crystal on silicon is a miniaturized reflective or transmissive active-matrix display having a liquid crystal layer disposed over a silicon backplane. During operation, light from a light source is directed at the liquid crystal layer and as the local orientation of the liquid crystals is modulated by a pixel-specific applied voltage, the phase retardation of the incident wavefront can be controlled to generate an image from the reflected or transmitted light. In some instantiations, a liquid crystal on silicon display may be referred to as a spatial light modulator (SLM).

In addition to modulating the image as a display or SLM, liquid crystals exhibit other attractive features, such as polymerization and photo-patternable properties, which can be leveraged to create photonic devices, i.e., LC planar optics or LC optical elements (LCOEs). Such devices may exhibit an ultrathin form factor, ˜100% efficiency, strong polarization selectivity, and switchability. In AR/VR systems, active LC components (e.g., switchable half waveplates) may be used to enable foveated rendering, field-of-view (FOV) steering, and discrete accommodation imaging.

Through the application of a voltage, active LC components may allow an optical system to have two different eigen polarization modes (i.e., TM and TE modes) at different times. For instance, in a foveal system, a pair of eigen polarization modes may enable a wide field-of-view and foveated rendering. In a discrete accommodation system, switchable eigen polarization modes may support temporally separate accommodation states. As will be appreciated, an active LC component may be configured to change the polarization state of image light, which may provide tunable image magnification (e.g., FOV) and adjustable resolution, for example.

Notwithstanding recent developments, it would be advantageous to develop an optical display having an improved fill factor and resolution and providing a foveal rendering without time multiplexing. As disclosed herein, an LC display includes an in-plane switching (IPS) element located within the optical path of the display pixels. In IPS, a layer of liquid crystals is sandwiched between two glass or polymer surfaces. The liquid crystal molecules may be aligned parallel to those surfaces in predetermined directions (in-plane). The molecules may be reoriented by an applied electric field.

The IPS element may be configured to rotate the output linear polarization states of image light emitted by the display, although in some embodiments, the function of polarization rotation may be accomplished by alternative structures. The rotated signal may be separated into two configurations (e.g., virtual pixels) simultaneously. That is, disclosed is a display having an active LC component configured to provide two different eigen polarization modes (i.e., TM and TE modes) concurrently. With the disclosed display system, a given polarization state may be decomposed into corresponding eigen states, or vice versa, in real time.

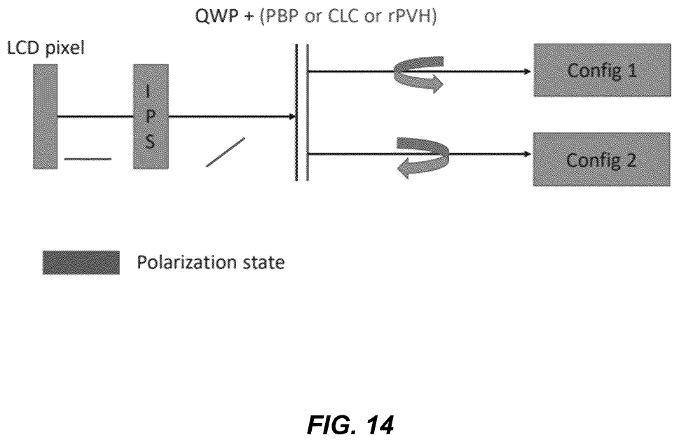

The following will provide, with reference to FIGS. 14-19, detailed descriptions of devices and related methods associated with polarization multiplexing. The discussion associated with FIGS. 14-19 includes a description of device architectures including an LC display and a co-integrated in-plane switching element.

Referring to FIG. 14, shown schematically is a liquid crystal display system that is adapted to operate in two configurations. For instance, a first configuration may be characterized by a large field of view and low resolution, and a second configuration may be characterize by a small field of view and high resolution. In some embodiments, the two configurations may be operated simultaneously.

As shown, an IPS overlies the display panel output. During operation, the output from the LCD may be linearly polarized. The IPS retarder may alter the polarization state of the image light and induce a desired rotation. The illustrated film stack (e.g., QWP+PBP or QWP+CLC or QWP+rPVH) can separate the two eigenstates from the rotated linearly polarized light, and the different eigenstates may be directed to the different configurations simultaneously. By adjusting the degree of rotation and the intensity of the image light, the signal intensity directed to each configuration may be independently controlled. The foregoing architecture obviates the need for a switchable half wave plate and may overcome challenges associated with such a comparative approach, including synchronization of the light directed to each configuration.

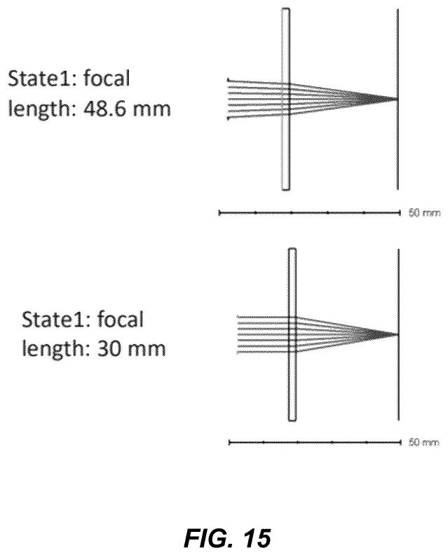

Referring to FIG. 15, the illustrated configuration includes two t-PVH lenses having orthogonal eigenstates and different focal lengths. With this design, the display system can present one or two accommodation states simultaneously without the need for a switchable half waveplate.

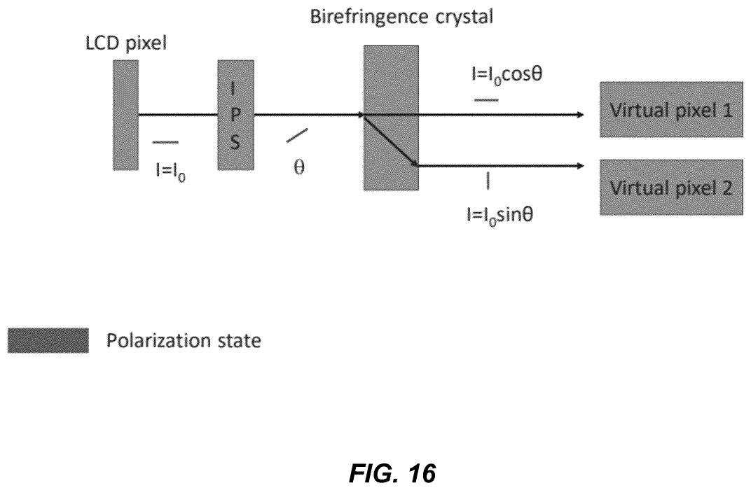

Referring to FIG. 16, shown is a high resolution display configuration according to some embodiments. As in the previous embodiment, linearly polarized output light from an LCD pixel may be rotated by an amount 6 by an IPS retarder located proximate to the display output. A birefringent crystal may decompose the rotated beam to respective eigen states that generate a pair of virtual pixels. By controlling the degree of rotation created by the IPS and the intensity (I) of the image light, the signal intensity directed to each virtual pixel may be independently adjusted. Such a configuration may improve resolution and fill factor along one dimension of a display output.

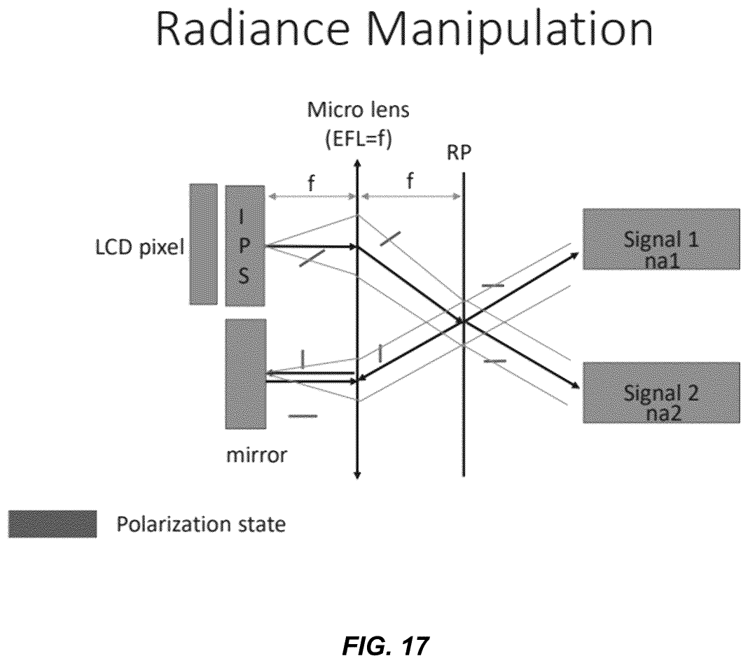

Referring to FIG. 17, in a further example display system, linearly polarized output light from an LCD pixel may be rotated by an IPS retarder located proximate to the display output. A microlens array is configured to focus the rotated light to a reflective polarizer (RP), which reflects one eigen state and transmits the complementary eigen state. The reflected light may be focused by the microlens to a mirror, whereupon the light is reflected with a change in its eigen state. The re-reflected light may be collimated and may propagate through the reflective polarizer. As will be appreciated, signal 1 and signal 2 may have different polarization states, i.e., first and second eigen states, each with a corresponding numerical aperture (na).

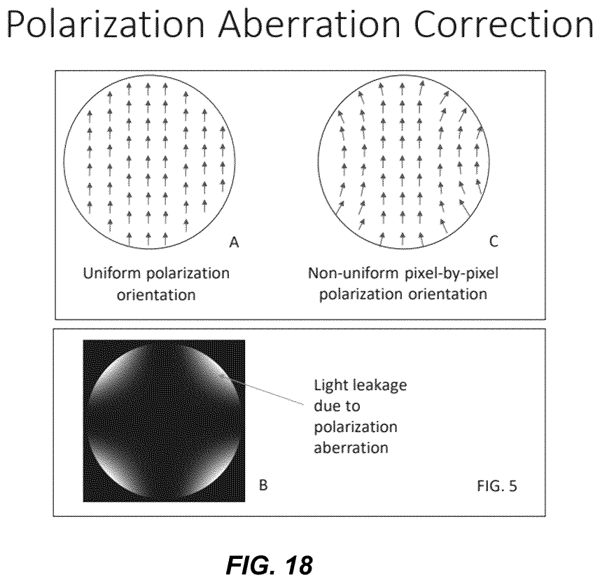

Turning now to FIG. 18, depicted in accordance with some embodiments are aspects of polarization aberration correction. As shown in FIG. 18A, a uniform polarizer may be configured to create a constant linear polarization state across an entire field of an optical system. However, with reference to FIG. 18B, in conjunction with such uniform polarization, light leakage may result due to inherent polarization aberrations. This effect may cause the formation of undesired ghost images, especially in pancake systems.

Applicants have shown that for some optical systems, a desired polarization state may be configured to vary spatially, e.g., from pixel to pixel. FIG. 18C depicts a system having pixel-specific linear polarization states. This design may be arranged to compensate for optical system-induced polarization aberrations, effectively minimizing the creating of ghost images.

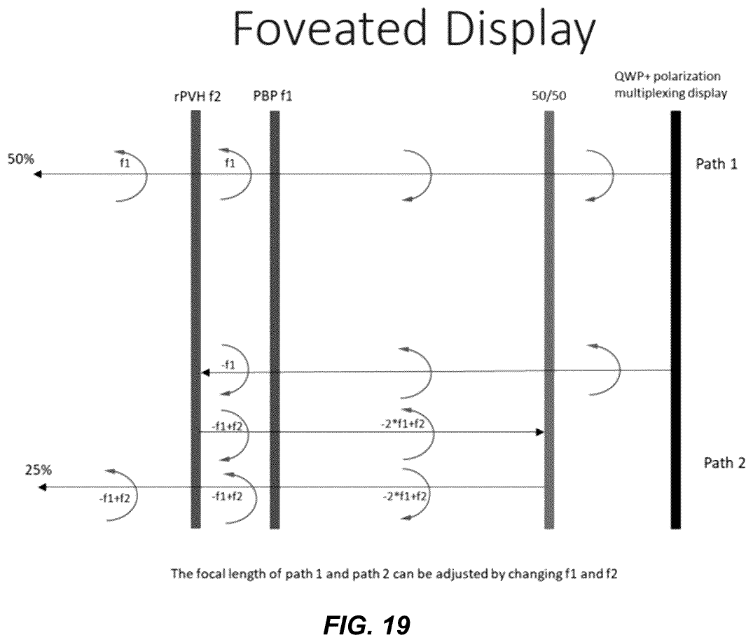

Furthermore, although various embodiments are described herein with reference to a liquid crystal display system having a co-integrated in-plane switching element, it will be appreciated that the disclosed approaches to polarization management may be incorporated into various other display platforms, including OLED and micro-OLED-based display systems. FIG. 19 is a schematic diagram of a foveated display including polarization multiplexing.

### Example Embodiments

Example 1: A system includes a liquid crystal display configured to output linearly polarized light and a switching element located proximate to an output of the liquid crystal display, the switching element configured to rotate a polarization state of the linearly polarized light.

### Optical Stack with Varifocal Component for Mitigating Vergence-Accommodation Conflict

The present disclosure is generally directed to optical stacks (e.g., pancake lenses) with varifocal components (e.g., that mitigate vergence-accommodation conflict). Presenting simulated or augmented scenery to a user of a near-eye display (e.g., for augmented reality and/or virtual reality systems) can cause discomfort resulting from a discrepancy between eye vergence and eye focusing to accommodate a visual distance (i.e., vergence-accommodation conflict). The vergence-accommodation conflict may be a result of changing vergence of a user's eyes depending on what virtual object the user is looking at, while the accommodation of the eyes is generally fixed and set by the distances between a display generating virtual images and a lens system projecting the images to the user's eyes.

Systems and devices described herein may mitigate vergence-accommodation conflict by introducing a varifocal component that changes the optical power of a lens system to accommodate the change in eye vergence.

In some examples, an optical stack (e.g., used to project images from a near-eye display) may include a pancake lens. The pancake lens may create a folded optical path, potentially reducing the distance between the display and the eye box. In some examples, the pancake lens may include a pair of lenses and two partial reflectors (e.g., a 50:50 mirror and a reflective polarizer) that create the folded optical path. In some examples, one partial reflector (e.g., a 50:50 mirror) may be at the display side of a first, display-side lens, while another partial reflector (e.g., a reflective polarizer) may be between the first, display-side lens and a second eye-side lens (e.g., on the eye side of the display-side lens or on the display side of the eye-side lens).

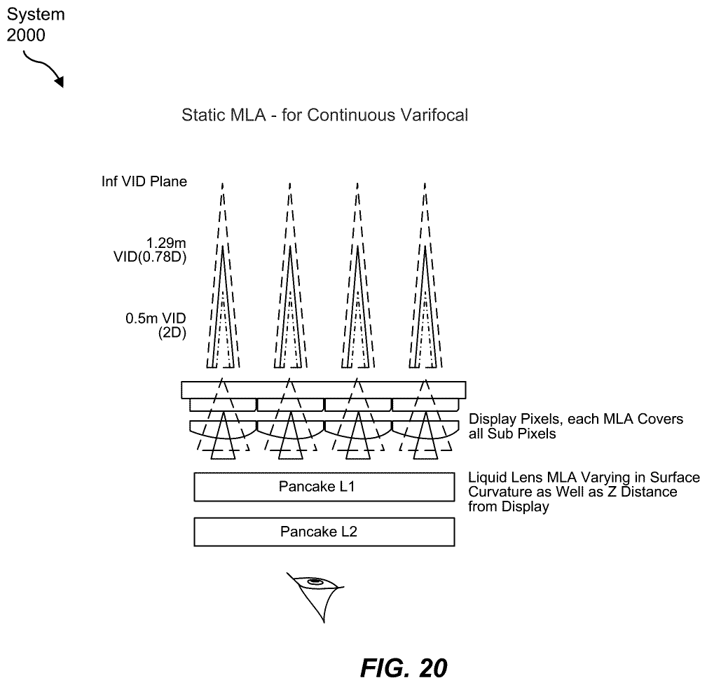

FIG. 20 is an illustration of an example varifocal display with a pancake lens and a micro lens array. In one example, a micro lens array may be placed in front of a display (e.g., a near-eye display) to create a varying focal length. In this example, the micro lens array may function at a single set frequency to create a fixed display image at a given focal distance.

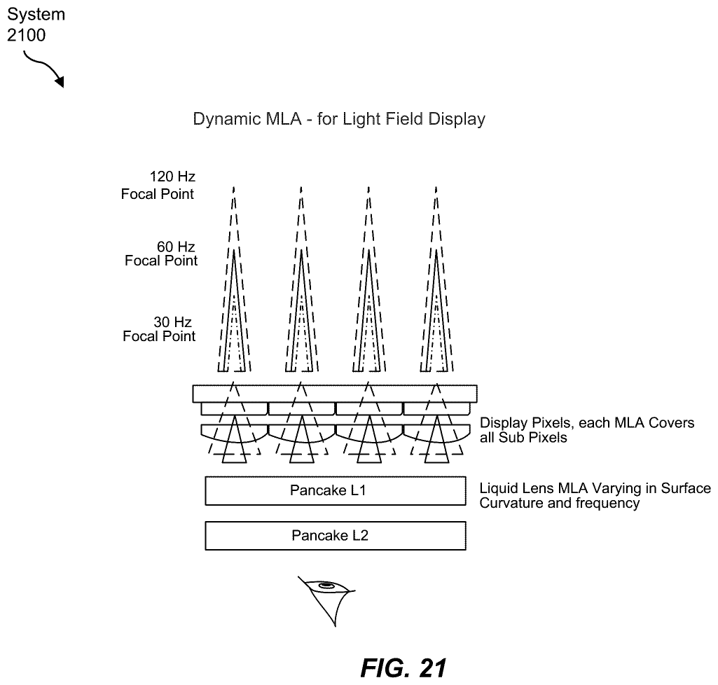

FIG. 21 is an illustration of an example light field display with a pancake lens and a micro lens array. As shown in FIG. 21, a micro lens array may be placed in front of a display (e.g., a near-eye display). In some examples, the systems described herein may periodically change the focal length of the micro lens array. For example, the frequency of focal length change may be matched with the display frequency to create multiple images from the display at different focal points, thereby creating a light field display.

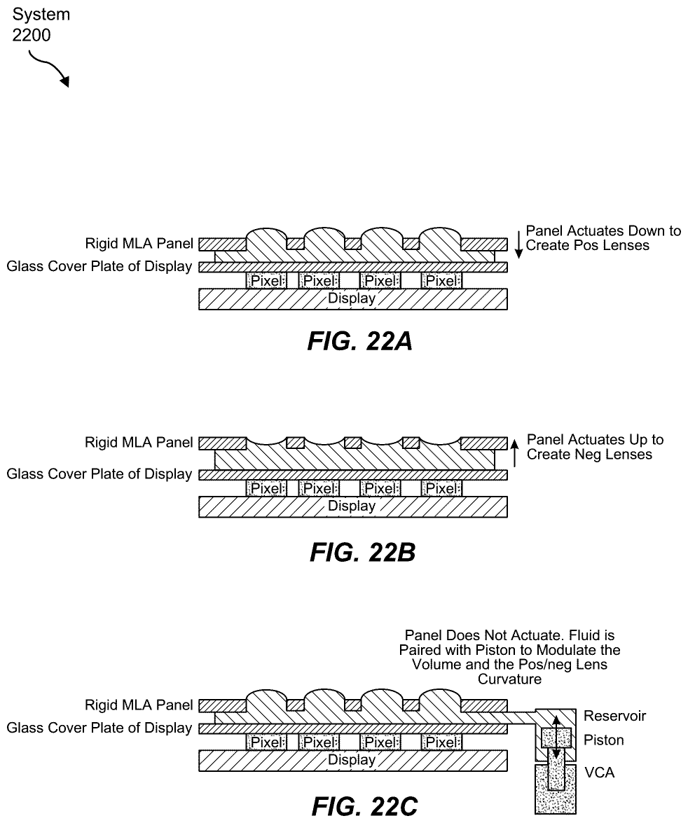

FIGS. 22A, 22B, and 22C are illustrations of a liquid micro lens array in various actuation states. As shown in FIGS. 22A, 22B, and 22C, a liquid micro lens array may be directly in front of and/or coupled to a display. In one example, as shown in FIGS. 22A and 22B, a panel set over a fluid-filled membrane may actuate down or up (e.g., toward or away from the display) to create an array of positive or negative lenses. In this example, actuation may be accomplished with an electrostatic actuator, a piezoelectric actuator, a voice coil actuator, and/or any other suitable actuation mechanism. In another example, as shown in FIG. 22C, the panel may not actuate (e.g., may remain fixed in place). Instead, fluid may enter or exit the membrane (e.g., from a reservoir via a piston).

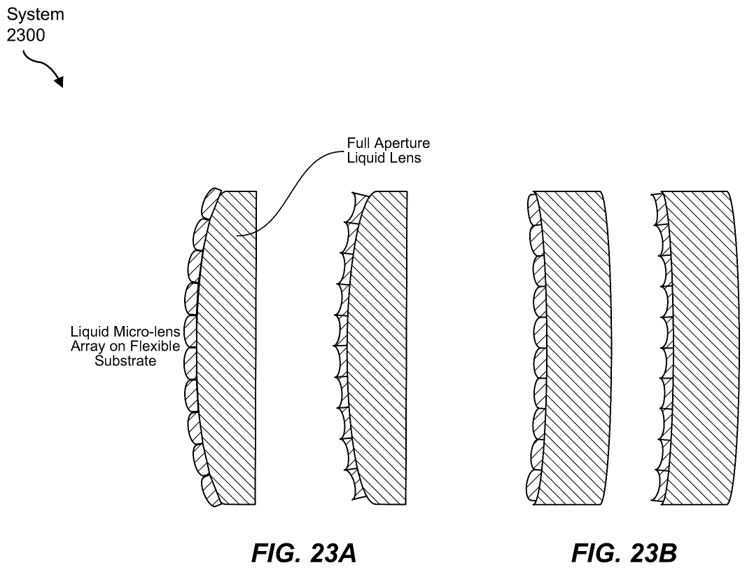

FIGS. 23A and 23B are illustrations of a liquid micro lens array on a liquid lens in various actuation states. As shown in FIGS. 23A and 23B, the curvature of the large liquid lens and the micro lens array may be modulated independently (e.g., using at least two separate cavities).

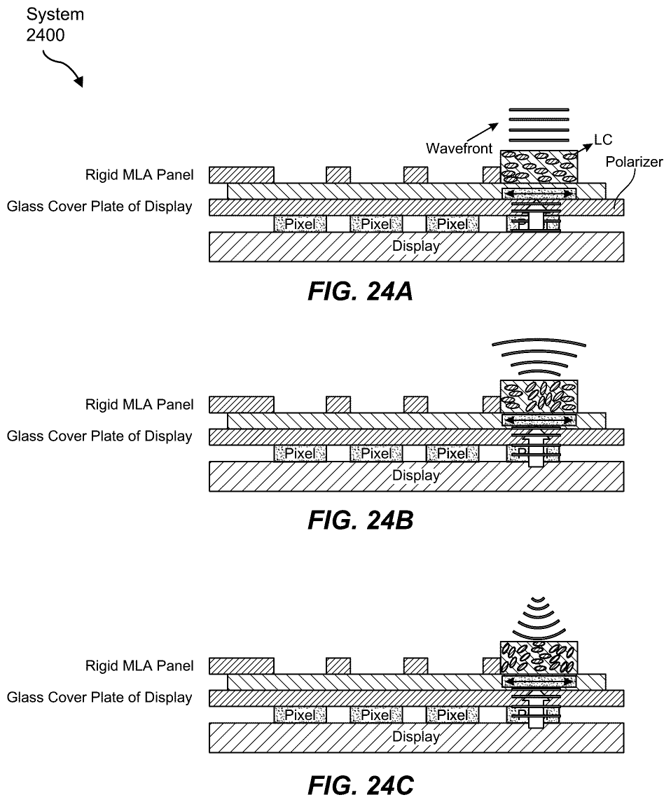

FIGS. 24A, 24B, and 24C are illustrations of an example liquid-crystal based micro lens array. As shown in FIGS. 24A, 24B, and 24C, by controlling the voltage across the liquid crystal cells, the liquid crystal cells may apply neutral, divergent, or convergent optical power. In some examples, the liquid crystal cells in the micro lens array may be driven together (e.g., achieving a uniform optical power across cells). In some examples, one or more of the liquid crystal cells may be driven independently from one or more of the other liquid crystal cells, applying varying optical power to different portions (e.g., pixels) of the display.

While FIGS. 20, 21, 22A, 22B, 22C, 24A, 24B, and 24C may each illustrate a micro lens array where each lens of the array is configured (e.g., sized and aligned) to cover one corresponding pixel of the display, in some examples each lens of a micro lens array may configured to cover more than one pixel of a display. By way of example, and without limitation, each lens of a micro lens array, such as any of the micro lens arrays discussed herein, may be configured to cover 4 pixels, 10 pixels, 16 pixels, or any other suitable number of pixels and/or portion of the display.

### Continuous Display with Sub-Frame Display Rendering to Account for Positional Viewing Changes

Low persistence displays are frequently used in head-mounted display systems to reduce image blur perceived by users. “Pixel persistence,” as used herein, refers to the amount of time per frame that a display is actually lit rather than black. “Low persistence,” as used herein, refers to a display in which the screen is lit for only a small fraction of the frame. For example, in a low persistence display system, the display pixels may be ON for approximately 10% of the time and OFF for approximately 90% of the time. A problem with low persistent displays involves the fact that the max potential brightness is relatively low due to the minimal amount of time that pixels are illuminated. Additionally, the frame time may result in the user waiting for the frame to be completed before additional frames are displayed, making images appear choppy or delayed, particularly during periods of user eye and/or head movement. These display problems are related the large amount of display downtime, with the display being OFF for approximately 90% of the time typically. Such a high proportion of display OFF time does not reflect how the real world works.

The present disclosure is generally directed to a display system in which individual image frames may be broken up into very small sub-frames. For example, during periods of more significant eye movement and/or head movement, a higher number of subframes may be utilized to produce a more natural visual experience for a user. The use of additional subframes may, for example, allow for more effective transitioning of the subframes to new locations on the display. This sub-frame image transitioning may result in image stabilization of the display in a manner analogous to image stabilization by a camera during image capture. This also allows for frames to be cut into the image display pipeline without having to wait for a frame to be completely displayed. A part of the sub-frame can be presented and be accounted for so a new frame/sub-frame can be presented.

In some examples, user eye and/or head movement may be monitored in any suitable manner to detect increased movement (e.g., saccades). Position and movement information may then be used to predict viewing location. Suitable sub-frames may then be generated for display at appropriate sub-frame intervals to produce an image that better corresponds to the user's viewing position. The view produced by adding the sub-frame images may produce a more realistic image transition where objects appear to move more naturally in relation to the user's view, with the overall image having less visual blur and increase brightness during the positional translation.

In at least one example, a buffered image may be generated to encompass an image buffer encompassing a field-of-view (FOV) that is larger than an FOV generated on the display visible to a viewer. The image buffer may be used to readily render additional sub-frames corresponding to dynamic user view changes as needed. The image buffer may be updated and moved with the user's view to render every sub-frame corresponding to world lock. This may allow for dynamic production of moving sub-frames with little or no display latency.

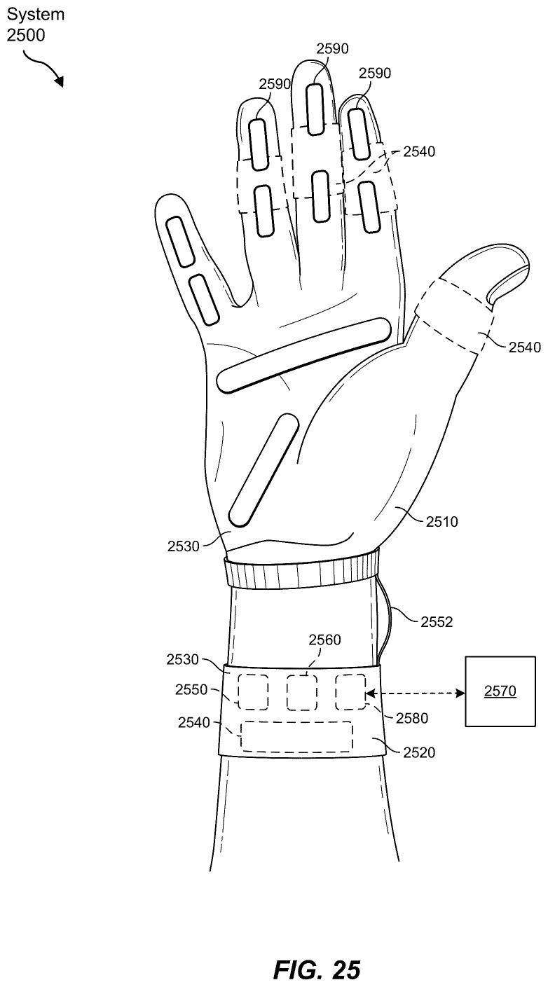

Haptic feedback may be provided by interfaces positioned within a user's environment (e.g., chairs, tables, floors, etc.) and/or interfaces on articles that may be worn or carried by a user (e.g., gloves, wristbands, etc.). As an example, FIG. 25 illustrates a vibrotactile system 2500 in the form of a wearable glove (haptic device 2510) and wristband (haptic device 2520). Haptic device 2510 and haptic device 2520 are shown as examples of wearable devices that include a flexible, wearable textile material 2530 that is shaped and configured for positioning against a user's hand and wrist, respectively. This disclosure also includes vibrotactile systems that may be shaped and configured for positioning against other human body parts, such as a finger, an arm, a head, a torso, a foot, or a leg. By way of example and not limitation, vibrotactile systems according to various embodiments of the present disclosure may also be in the form of a glove, a headband, an armband, a sleeve, a head covering, a sock, a shirt, or pants, among other possibilities. In some examples, the term “textile” may include any flexible, wearable material, including woven fabric, non-woven fabric, leather, cloth, a flexible polymer material, composite materials, etc.

One or more vibrotactile devices 2540 may be positioned at least partially within one or more corresponding pockets formed in textile material 2530 of vibrotactile system 2500. Vibrotactile devices 2540 may be positioned in locations to provide a vibrating sensation (e.g., haptic feedback) to a user of vibrotactile system 2500. For example, vibrotactile devices 2540 may be positioned against the user's finger(s), thumb, or wrist, as shown in FIG. 25. Vibrotactile devices 2540 may, in some examples, be sufficiently flexible to conform to or bend with the user's corresponding body part(s).

A power source 2550 (e.g., a battery) for applying a voltage to the vibrotactile devices 2540 for activation thereof may be electrically coupled to vibrotactile devices 2540, such as via conductive wiring 2552. In some examples, each of vibrotactile devices 2540 may be independently electrically coupled to power source 2550 for individual activation. In some embodiments, a processor 2560 may be operatively coupled to power source 2550 and configured (e.g., programmed) to control activation of vibrotactile devices 2540.

Vibrotactile system 2500 may be implemented in a variety of ways. In some examples, vibrotactile system 2500 may be a standalone system with integral subsystems and components for operation independent of other devices and systems. As another example, vibrotactile system 2500 may be configured for interaction with another device or system 2570. For example, vibrotactile system 2500 may, in some examples, include a communications interface 2580 for receiving and/or sending signals to the other device or system 2570. The other device or system 2570 may be a mobile device, a gaming console, an artificial-reality (e.g., virtual-reality, augmented-reality, mixed-reality) device, a personal computer, a tablet computer, a network device (e.g., a modem, a router, etc.), a handheld controller, etc. Communications interface 2580 may enable communications between vibrotactile system 2500 and the other device or system 2570 via a wireless (e.g., Wi-Fi, BLUETOOTH, cellular, radio, etc.) link or a wired link. If present, communications interface 2580 may be in communication with processor 2560, such as to provide a signal to processor 2560 to activate or deactivate one or more of the vibrotactile devices 2540.

Vibrotactile system 2500 may optionally include other subsystems and components, such as touch-sensitive pads 2590, pressure sensors, motion sensors, position sensors, lighting elements, and/or user interface elements (e.g., an on/off button, a vibration control element, etc.). During use, vibrotactile devices 2540 may be configured to be activated for a variety of different reasons, such as in response to the user's interaction with user interface elements, a signal from the motion or position sensors, a signal from the touch-sensitive pads 2590, a signal from the pressure sensors, a signal from the other device or system 2570, etc.

Although power source 2550, processor 2560, and communications interface 2580 are illustrated in FIG. 25 as being positioned in haptic device 2520, the present disclosure is not so limited. For example, one or more of power source 2550, processor 2560, or communications interface 2580 may be positioned within haptic device 2510 or within another wearable textile.

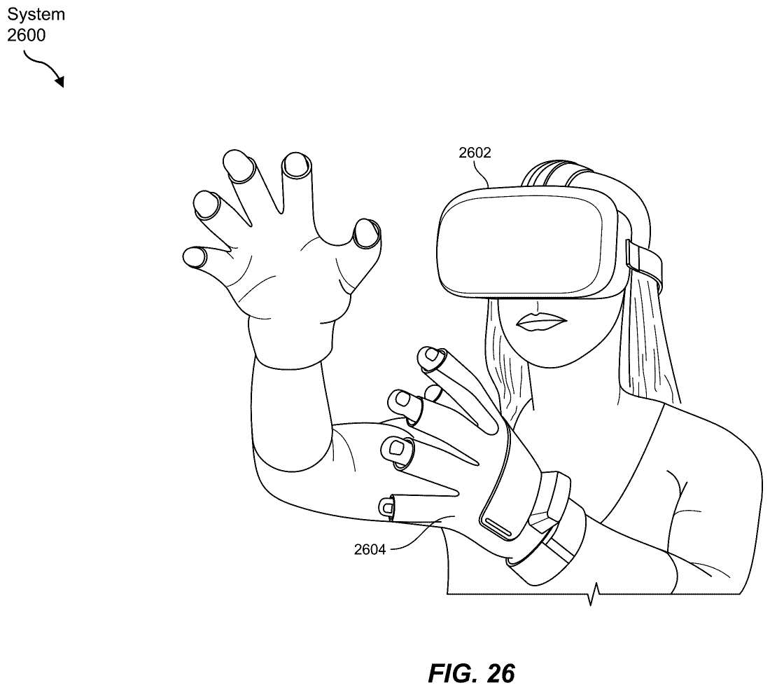

Haptic wearables, such as those shown in and described in connection with FIG. 25, may be implemented in a variety of types of artificial-reality systems and environments. FIG. 26 shows an example artificial-reality environment 2600 including one head-mounted virtual-reality display and two haptic devices (i.e., gloves), and in other embodiments any number and/or combination of these components and other components may be included in an artificial-reality system. For example, in some embodiments there may be multiple head-mounted displays each having an associated haptic device, with each head-mounted display and each haptic device communicating with the same console, portable computing device, or other computing system.

Head-mounted display 2602 generally represents any type or form of virtual-reality system, such as virtual-reality system 700 in FIG. 7. Haptic device 2604 generally represents any type or form of wearable device, worn by a user of an artificial-reality system, that provides haptic feedback to the user to give the user the perception that he or she is physically engaging with a virtual object. In some embodiments, haptic device 2604 may provide haptic feedback by applying vibration, motion, and/or force to the user. For example, haptic device 2604 may limit or augment a user's movement. To give a specific example, haptic device 2604 may limit a user's hand from moving forward so that the user has the perception that his or her hand has come in physical contact with a virtual wall. In this specific example, one or more actuators within the haptic device may achieve the physical-movement restriction by pumping fluid into an inflatable bladder of the haptic device. In some examples, a user may also use haptic device 2604 to send action requests to a console. Examples of action requests include, without limitation, requests to start an application and/or end the application and/or requests to perform a particular action within the application.

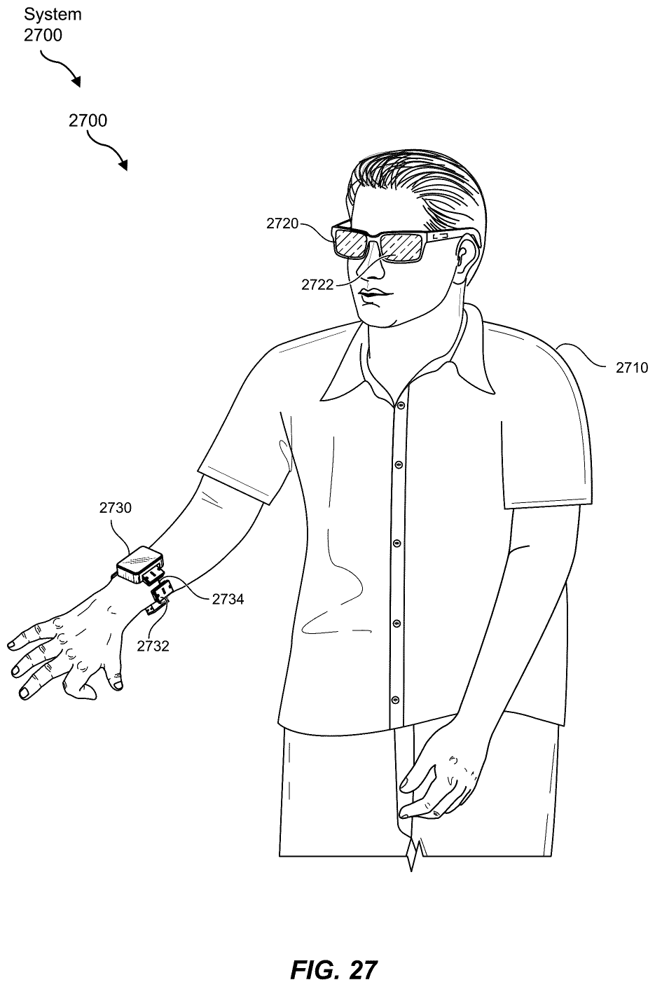

While haptic interfaces may be used with virtual-reality systems, as shown in FIG. 26, haptic interfaces may also be used with augmented-reality systems, as shown in FIG. 27. FIG. 27 is a perspective view of a user 2710 interacting with an augmented-reality system 2700. In this example, user 2710 may wear a pair of augmented-reality glasses 2720 that may have one or more displays 2722 and that are paired with a haptic device 2730. In this example, haptic device 2730 may be a wristband that includes a plurality of band elements 2732 and a tensioning mechanism 2734 that connects band elements 2732 to one another.

One or more of band elements 2732 may include any type or form of actuator suitable for providing haptic feedback. For example, one or more of band elements 2732 may be configured to provide one or more of various types of cutaneous feedback, including vibration, force, traction, texture, and/or temperature. To provide such feedback, band elements 2732 may include one or more of various types of actuators. In one example, each of band elements 2732 may include a vibrotactor (e.g., a vibrotactile actuator) configured to vibrate in unison or independently to provide one or more of various types of haptic sensations to a user. Alternatively, only a single band element or a subset of band elements may include vibrotactors.

Haptic devices 2510, 2520, 2604, and 2730 may include any suitable number and/or type of haptic transducer, sensor, and/or feedback mechanism. For example, haptic devices 2510, 2520, 2604, and 2730 may include one or more mechanical transducers, piezoelectric transducers, and/or fluidic transducers. Haptic devices 2510, 2520, 2604, and 2730 may also include various combinations of different types and forms of transducers that work together or independently to enhance a user's artificial-reality experience. In one example, each of band elements 2732 of haptic device 2730 may include a vibrotactor (e.g., a vibrotactile actuator) configured to vibrate in unison or independently to provide one or more of various types of haptic sensations to a user.

In some embodiments, the systems described herein may also include an eye-tracking subsystem designed to identify and track various characteristics of a user's eye(s), such as the user's gaze direction. The phrase “eye tracking” may, in some examples, refer to a process by which the position, orientation, and/or motion of an eye is measured, detected, sensed, determined, and/or monitored. The disclosed systems may measure the position, orientation, and/or motion of an eye in a variety of different ways, including through the use of various optical-based eye-tracking techniques, ultrasound-based eye-tracking techniques, etc. An eye-tracking subsystem may be configured in a number of different ways and may include a variety of different eye-tracking hardware components or other computer-vision components. For example, an eye-tracking subsystem may include a variety of different optical sensors, such as two-dimensional (2D) or 3D cameras, time-of-flight depth sensors, single-beam or sweeping laser rangefinders, 3D LiDAR sensors, and/or any other suitable type or form of optical sensor. In this example, a processing subsystem may process data from one or more of these sensors to measure, detect, determine, and/or otherwise monitor the position, orientation, and/or motion of the user's eye(s).

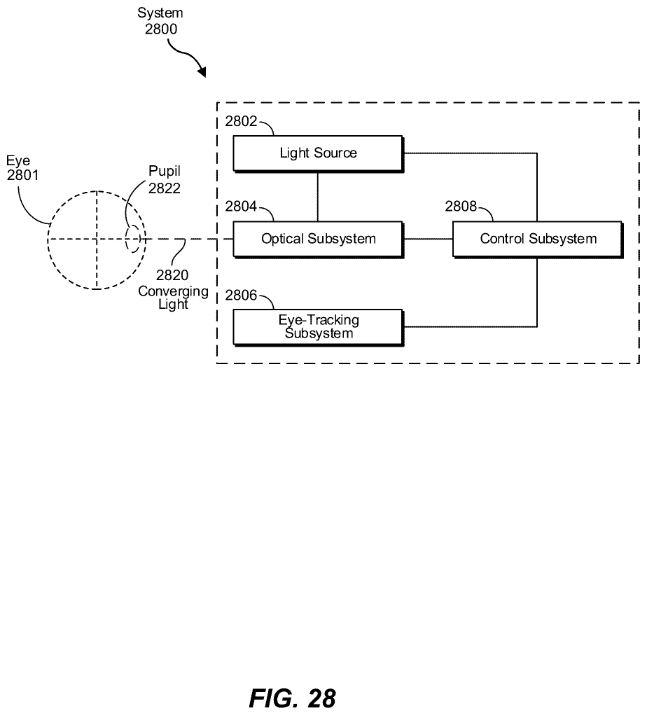

FIG. 28 is an illustration of an example system 2800 that incorporates an eye-tracking subsystem capable of tracking a user's eye(s). As depicted in FIG. 28, system 2800 may include a light source 2802, an optical subsystem 2804, an eye-tracking subsystem 2806, and/or a control subsystem 2808. In some examples, light source 2802 may generate light for an image (e.g., to be presented to an eye 2801 of the viewer). Light source 2802 may represent any of a variety of suitable devices. For example, light source 2802 can include a two-dimensional projector (e.g., a LCoS display), a scanning source (e.g., a scanning laser), or other device (e.g., an LCD, an LED display, an OLED display, an active-matrix OLED display (AMOLED), a transparent OLED display (TOLED), a waveguide, or some other display capable of generating light for presenting an image to the viewer). In some examples, the image may represent a virtual image, which may refer to an optical image formed from the apparent divergence of light rays from a point in space, as opposed to an image formed from the light ray's actual divergence.

In some embodiments, optical subsystem 2804 may receive the light generated by light source 2802 and generate, based on the received light, converging light 2820 that includes the image. In some examples, optical subsystem 2804 may include any number of lenses (e.g., Fresnel lenses, convex lenses, concave lenses), apertures, filters, mirrors, prisms, and/or other optical components, possibly in combination with actuators and/or other devices. In particular, the actuators and/or other devices may translate and/or rotate one or more of the optical components to alter one or more aspects of converging light 2820. Further, various mechanical couplings may serve to maintain the relative spacing and/or the orientation of the optical components in any suitable combination.

In one embodiment, eye-tracking subsystem 2806 may generate tracking information indicating a gaze angle of an eye 2801 of the viewer. In this embodiment, control subsystem 2808 may control aspects of optical subsystem 2804 (e.g., the angle of incidence of converging light 2820) based at least in part on this tracking information. Additionally, in some examples, control subsystem 2808 may store and utilize historical tracking information (e.g., a history of the tracking information over a given duration, such as the previous second or fraction thereof) to anticipate the gaze angle of eye 2801 (e.g., an angle between the visual axis and the anatomical axis of eye 2801). In some embodiments, eye-tracking subsystem 2806 may detect radiation emanating from some portion of eye 2801 (e.g., the cornea, the iris, the pupil, or the like) to determine the current gaze angle of eye 2801. In other examples, eye-tracking subsystem 2806 may employ a wavefront sensor to track the current location of the pupil.

Any number of techniques can be used to track eye 2801. Some techniques may involve illuminating eye 2801 with infrared light and measuring reflections with at least one optical sensor that is tuned to be sensitive to the infrared light. Information about how the infrared light is reflected from eye 2801 may be analyzed to determine the position(s), orientation(s), and/or motion(s) of one or more eye feature(s), such as the cornea, pupil, iris, and/or retinal blood vessels.

In some examples, the radiation captured by a sensor of eye-tracking subsystem 2806 may be digitized (i.e., converted to an electronic signal). Further, the sensor may transmit a digital representation of this electronic signal to one or more processors (for example, processors associated with a device including eye-tracking subsystem 2806). Eye-tracking subsystem 2806 may include any of a variety of sensors in a variety of different configurations. For example, eye-tracking subsystem 2806 may include an infrared detector that reacts to infrared radiation. The infrared detector may be a thermal detector, a photonic detector, and/or any other suitable type of detector. Thermal detectors may include detectors that react to thermal effects of the incident infrared radiation.

In some examples, one or more processors may process the digital representation generated by the sensor(s) of eye-tracking subsystem 2806 to track the movement of eye 2801. In another example, these processors may track the movements of eye 2801 by executing algorithms represented by computer-executable instructions stored on non-transitory memory. In some examples, on-chip logic (e.g., an application-specific integrated circuit or ASIC) may be used to perform at least portions of such algorithms. As noted, eye-tracking subsystem 2806 may be programmed to use an output of the sensor(s) to track movement of eye 2801. In some embodiments, eye-tracking subsystem 2806 may analyze the digital representation generated by the sensors to extract eye rotation information from changes in reflections. In one embodiment, eye-tracking subsystem 2806 may use corneal reflections or glints (also known as Purkinje images) and/or the center of the eye's pupil 2822 as features to track over time.

In some embodiments, eye-tracking subsystem 2806 may use the center of the eye's pupil 2822 and infrared or near-infrared, non-collimated light to create corneal reflections. In these embodiments, eye-tracking subsystem 2806 may use the vector between the center of the eye's pupil 2822 and the corneal reflections to compute the gaze direction of eye 2801. In some embodiments, the disclosed systems may perform a calibration procedure for an individual (using, e.g., supervised or unsupervised techniques) before tracking the user's eyes. For example, the calibration procedure may include directing users to look at one or more points displayed on a display while the eye-tracking system records the values that correspond to each gaze position associated with each point.

In some embodiments, eye-tracking subsystem 2806 may use two types of infrared and/or near-infrared (also known as active light) eye-tracking techniques: bright-pupil and dark-pupil eye tracking, which may be differentiated based on the location of an illumination source with respect to the optical elements used. If the illumination is coaxial with the optical path, then eye 2801 may act as a retroreflector as the light reflects off the retina, thereby creating a bright pupil effect similar to a red-eye effect in photography. If the illumination source is offset from the optical path, then the eye's pupil 2822 may appear dark because the retroreflection from the retina is directed away from the sensor. In some embodiments, bright-pupil tracking may create greater iris/pupil contrast, allowing more robust eye tracking with iris pigmentation, and may feature reduced interference (e.g., interference caused by eyelashes and other obscuring features). Bright-pupil tracking may also allow tracking in lighting conditions ranging from total darkness to a very bright environment.

In some embodiments, control subsystem 2808 may control light source 2802 and/or optical subsystem 2804 to reduce optical aberrations (e.g., chromatic aberrations and/or monochromatic aberrations) of the image that may be caused by or influenced by eye 2801. In some examples, as mentioned above, control subsystem 2808 may use the tracking information from eye-tracking subsystem 2806 to perform such control. For example, in controlling light source 2802, control subsystem 2808 may alter the light generated by light source 2802 (e.g., by way of image rendering) to modify (e.g., pre-distort) the image so that the aberration of the image caused by eye 2801 is reduced.

The disclosed systems may track both the position and relative size of the pupil (since, e.g., the pupil dilates and/or contracts). In some examples, the eye-tracking devices and components (e.g., sensors and/or sources) used for detecting and/or tracking the pupil may be different (or calibrated differently) for different types of eyes. For example, the frequency range of the sensors may be different (or separately calibrated) for eyes of different colors and/or different pupil types, sizes, and/or the like. As such, the various eye-tracking components (e.g., infrared sources and/or sensors) described herein may need to be calibrated for each individual user and/or eye.

The disclosed systems may track both eyes with and without ophthalmic correction, such as that provided by contact lenses worn by the user. In some embodiments, ophthalmic correction elements (e.g., adjustable lenses) may be directly incorporated into the artificial reality systems described herein. In some examples, the color of the user's eye may necessitate modification of a corresponding eye-tracking algorithm. For example, eye-tracking algorithms may need to be modified based at least in part on the differing color contrast between a brown eye and, for example, a blue eye.

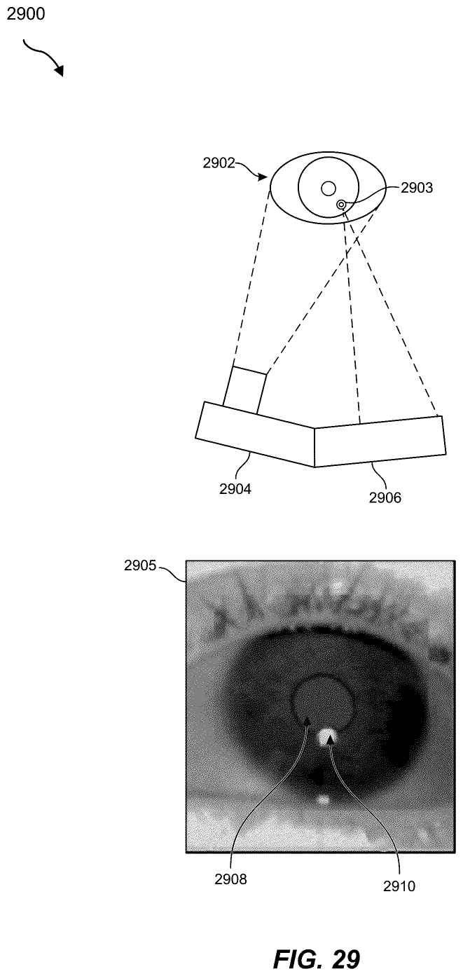

FIG. 29 is a more detailed illustration of various aspects of the eye-tracking subsystem illustrated in FIG. 28. As shown in this figure, an eye-tracking subsystem 2900 may include at least one source 2904 and at least one sensor 2906. Source 2904 generally represents any type or form of element capable of emitting radiation. In one example, source 2904 may generate visible, infrared, and/or near-infrared radiation. In some examples, source 2904 may radiate non-collimated infrared and/or near-infrared portions of the electromagnetic spectrum towards an eye 2902 of a user. Source 2904 may utilize a variety of sampling rates and speeds. For example, the disclosed systems may use sources with higher sampling rates in order to capture fixational eye movements of a user's eye 2902 and/or to correctly measure saccade dynamics of the user's eye 2902. As noted above, any type or form of eye-tracking technique may be used to track the user's eye 2902, including optical-based eye-tracking techniques, ultrasound-based eye-tracking techniques, etc.

Sensor 2906 generally represents any type or form of element capable of detecting radiation, such as radiation reflected off the user's eye 2902. Examples of sensor 2906 include, without limitation, a charge coupled device (CCD), a photodiode array, a complementary metal-oxide-semiconductor (CMOS) based sensor device, and/or the like. In one example, sensor 2906 may represent a sensor having predetermined parameters, including, but not limited to, a dynamic resolution range, linearity, and/or other characteristic selected and/or designed specifically for eye tracking.

As detailed above, eye-tracking subsystem 2900 may generate one or more glints. As detailed above, a glint 2903 may represent reflections of radiation (e.g., infrared radiation from an infrared source, such as source 2904) from the structure of the user's eye. In various embodiments, glint 2903 and/or the user's pupil may be tracked using an eye-tracking algorithm executed by a processor (either within or external to an artificial reality device). For example, an artificial reality device may include a processor and/or a memory device in order to perform eye tracking locally and/or a transceiver to send and receive the data necessary to perform eye tracking on an external device (e.g., a mobile phone, cloud server, or other computing device).

FIG. 29 shows an example image 2905 captured by an eye-tracking subsystem, such as eye-tracking subsystem 2900. In this example, image 2905 may include both the user's pupil 2908 and a glint 2910 near the same. In some examples, pupil 2908 and/or glint 2910 may be identified using an artificial-intelligence-based algorithm, such as a computer-vision-based algorithm. In one embodiment, image 2905 may represent a single frame in a series of frames that may be analyzed continuously in order to track the eye 2902 of the user. Further, pupil 2908 and/or glint 2910 may be tracked over a period of time to determine a user's gaze.

In one example, eye-tracking subsystem 2900 may be configured to identify and measure the inter-pupillary distance (IPD) of a user. In some embodiments, eye-tracking subsystem 2900 may measure and/or calculate the IPD of the user while the user is wearing the artificial reality system. In these embodiments, eye-tracking subsystem 2900 may detect the positions of a user's eyes and may use this information to calculate the user's IPD.

As noted, the eye-tracking systems or subsystems disclosed herein may track a user's eye position and/or eye movement in a variety of ways. In one example, one or more light sources and/or optical sensors may capture an image of the user's eyes. The eye-tracking subsystem may then use the captured information to determine the user's inter-pupillary distance, interocular distance, and/or a 3D position of each eye (e.g., for distortion adjustment purposes), including a magnitude of torsion and rotation (i.e., roll, pitch, and yaw) and/or gaze directions for each eye. In one example, infrared light may be emitted by the eye-tracking subsystem and reflected from each eye. The reflected light may be received or detected by an optical sensor and analyzed to extract eye rotation data from changes in the infrared light reflected by each eye.

The eye-tracking subsystem may use any of a variety of different methods to track the eyes of a user. For example, a light source (e.g., infrared light-emitting diodes) may emit a dot pattern onto each eye of the user. The eye-tracking subsystem may then detect (e.g., via an optical sensor coupled to the artificial reality system) and analyze a reflection of the dot pattern from each eye of the user to identify a location of each pupil of the user. Accordingly, the eye-tracking subsystem may track up to six degrees of freedom of each eye (i.e., 3D position, roll, pitch, and yaw) and at least a subset of the tracked quantities may be combined from two eyes of a user to estimate a gaze point (i.e., a 3D location or position in a virtual scene where the user is looking) and/or an IPD.

In some cases, the distance between a user's pupil and a display may change as the user's eye moves to look in different directions. The varying distance between a pupil and a display as viewing direction changes may be referred to as “pupil swim” and may contribute to distortion perceived by the user as a result of light focusing in different locations as the distance between the pupil and the display changes. Accordingly, measuring distortion at different eye positions and pupil distances relative to displays and generating distortion corrections for different positions and distances may allow mitigation of distortion caused by pupil swim by tracking the 3D position of a user's eyes and applying a distortion correction corresponding to the 3D position of each of the user's eyes at a given point in time. Thus, knowing the 3D position of each of a user's eyes may allow for the mitigation of distortion caused by changes in the distance between the pupil of the eye and the display by applying a distortion correction for each 3D eye position. Furthermore, as noted above, knowing the position of each of the user's eyes may also enable the eye-tracking subsystem to make automated adjustments for a user's IPD.

In some embodiments, a display subsystem may include a variety of additional subsystems that may work in conjunction with the eye-tracking subsystems described herein. For example, a display subsystem may include a varifocal subsystem, a scene-rendering module, and/or a vergence-processing module. The varifocal subsystem may cause left and right display elements to vary the focal distance of the display device. In one embodiment, the varifocal subsystem may physically change the distance between a display and the optics through which it is viewed by moving the display, the optics, or both. Additionally, moving or translating two lenses relative to each other may also be used to change the focal distance of the display. Thus, the varifocal subsystem may include actuators or motors that move displays and/or optics to change the distance between them. This varifocal subsystem may be separate from or integrated into the display subsystem. The varifocal subsystem may also be integrated into or separate from its actuation subsystem and/or the eye-tracking subsystems described herein.

In one example, the display subsystem may include a vergence-processing module configured to determine a vergence depth of a user's gaze based on a gaze point and/or an estimated intersection of the gaze lines determined by the eye-tracking subsystem. Vergence may refer to the simultaneous movement or rotation of both eyes in opposite directions to maintain single binocular vision, which may be naturally and automatically performed by the human eye. Thus, a location where a user's eyes are verged is where the user is looking and is also typically the location where the user's eyes are focused. For example, the vergence-processing module may triangulate gaze lines to estimate a distance or depth from the user associated with intersection of the gaze lines. The depth associated with intersection of the gaze lines may then be used as an approximation for the accommodation distance, which may identify a distance from the user where the user's eyes are directed. Thus, the vergence distance may allow for the determination of a location where the user's eyes should be focused and a depth from the user's eyes at which the eyes are focused, thereby providing information (such as an object or plane of focus) for rendering adjustments to the virtual scene.

The vergence-processing module may coordinate with the eye-tracking subsystems described herein to make adjustments to the display subsystem to account for a user's vergence depth. When the user is focused on something at a distance, the user's pupils may be slightly farther apart than when the user is focused on something close. The eye-tracking subsystem may obtain information about the user's vergence or focus depth and may adjust the display subsystem to be closer together when the user's eyes focus or verge on something close and to be farther apart when the user's eyes focus or verge on something at a distance.

The eye-tracking information generated by the above-described eye-tracking subsystems may also be used, for example, to modify various aspect of how different computer-generated images are presented. For example, a display subsystem may be configured to modify, based on information generated by an eye-tracking subsystem, at least one aspect of how the computer-generated images are presented. For instance, the computer-generated images may be modified based on the user's eye movement, such that if a user is looking up, the computer-generated images may be moved upward on the screen. Similarly, if the user is looking to the side or down, the computer-generated images may be moved to the side or downward on the screen. If the user's eyes are closed, the computer-generated images may be paused or removed from the display and resumed once the user's eyes are back open.

The above-described eye-tracking subsystems can be incorporated into one or more of the various artificial reality systems described herein in a variety of ways. For example, one or more of the various components of system 2800 and/or eye-tracking subsystem 2900 may be incorporated into augmented-reality system 600 in FIG. 6 and/or virtual-reality system 700 in FIG. 7 to enable these systems to perform various eye-tracking tasks (including one or more of the eye-tracking operations described herein).

### Theoretical Evaluation of Diffractive Input Couplers

Virtual reality and augmented reality devices and headsets typically include an optical system having a microdisplay and imaging optics. The microdisplay is configured to provide an image to be viewed either directly or indirectly using, for example, a micro OLED display or by illuminating a liquid-crystal based display such as a liquid crystal on silicon (LCoS) microdisplay. Display light may be projected to the eyes of a user using a waveguide where the light is in-coupled into the waveguide, transported therethrough by total internal reflection (TIR), and out-coupled when reaching the position of a viewer's eye.

Considerable effort has been devoted to augmented reality (AR) displays to provide a realistic immersive user experience in a wearable form factor. Transparent waveguide combiners offer a compact solution to guide light from the microdisplay to the user's eyes while maintaining a see-through optical path to simultaneously view the real world. To deliver a realistic virtual image with low power consumption, the waveguide combiners may have both high efficiency and good image quality.

A challenge that impacts the efficiency of diffractive waveguide combiners is the out-coupling of light through in-coupling elements, where guided light interacts with the input gratings and is partially out-coupled from the waveguide. Notwithstanding recent developments, it would be advantageous to provide a highly efficient waveguide combiner for delivering a quality image in an AR display.

Disclosed is a theoretical model to deterministically evaluate the upper bound of the input efficiency of a uniform input grating. The model considers the polarization management at the input coupler and can be applied to an arbitrary input polarization state ensemble. The model also provides the corresponding characteristics of the input coupler, such as the grating diffraction efficiencies and the Jones matrix of the polarization management components, to achieve an optimal input efficiency.

Equipped with this theoretical model, it is possible to determine how the upper bound of input efficiency varies with geometric parameters including the waveguide thickness, the projector pupil size, and the projector pupil relief distance. The model may help elucidate the fundamental efficiency limits of input couplers in diffractive waveguide combiners and highlight the benefits of polarization control in improving the input efficiency.

Among various augmented reality device architectures, waveguide combiners offer several advantages. In some aspects, waveguide combiners are spatially compact. A waveguide combiner architecture typically includes a sub-millimeter thick waveguide substrate and a projector, e.g., liquid crystal on silicon (LCoS), micro light emitting diode (mLED), laser beam scanning (LBS) projector, digital light projector (DLP), and the like. With a microdisplay, the projector can be integrated into the frame of the glasses. A waveguide combiner can provide a large eyebox through pupil replication, where the etundue constraint on light may be relaxed. In contrast, in other architectures such as Maxwellian view displays, the etundue constraint is conserved, such that it may be challenging to achieve large a field of view (FOV) and a large eyebox simultaneously with a compact form factor. Finally, in comparison with steered retinal projection systems, waveguide combiners may not require active tuning optical elements nor strongly depend on eye-tracking.

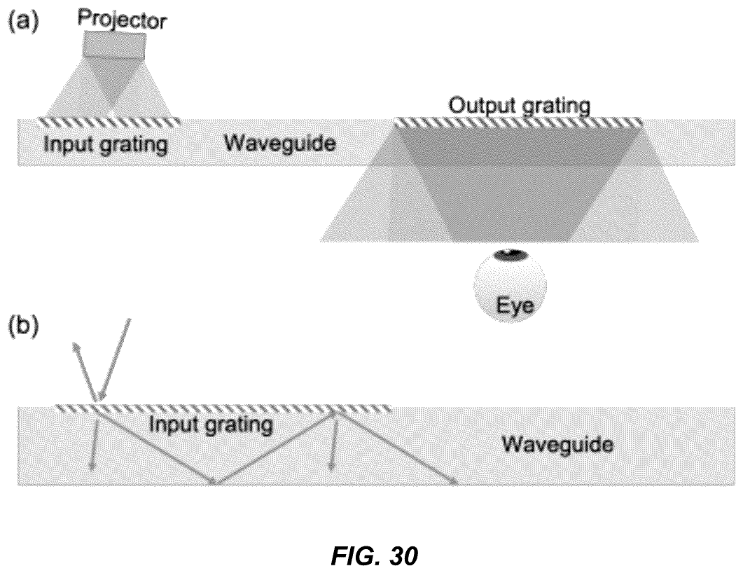

The following will provide, with reference to FIGS. 30-44, detailed descriptions of a quantitative evaluation of diffractive input couplers. The discussion associated with FIGS. 30-44 includes a description of various aspects of a theoretical model for evaluating and leveraging the input efficiency of the input grating of a waveguide combiner.

Referring to FIG. 30, a waveguide combiner is typically formed from a transparent dielectric substrate having a sub-millimeter thickness. Input and output couplers are configured as diffractive gratings, such as with diffractive waveguide combiners, or semi-reflective mirrors. In a diffractive waveguide combiner, collimated light from a projector is diffracted by the input grating and becomes guided in the waveguide. To confine light within the waveguide, the propagation angle of the guided light may be larger than the critical angle for total internal reflection (TIR). The guided light may then interact with one output grating, such as for one-dimensional pupil expansion, or two output gratings for two-dimensional pupil expansion.

After interaction with the output grating, light propagates to the eye of a user with the same direction as the light coming from the projector, as illustrated in FIG. 30A. With an extended etundue to achieve a large eyebox, the input power may be spread into a larger spatial-angular phase space where some of the out-coupled light does not reach the eyebox. As such, achieving a desired brightness is a prominent bottleneck for waveguide combiners. In diffractive waveguide combiners, an important loss channel occurs at the input couplers due to out-coupling. As illustrated in FIG. 30B, when the guided light interacts with the input grating, some of the guided light may be diffracted and outcoupled. Moreover, due to reciprocity, the probability of light being outcoupled is proportional to the diffraction efficiency of the grating.

To improve the efficiency of waveguide combiners, the efficiency of the input couplers may be improved, which may be pursued with an investigation of the upper bounds set by physics. The presently-disclosed model includes a theoretical analysis of the input grating and a study of the upper bound of its efficiency. Provided are numerical demonstrations on uniform input gratings, which may be generalized to include spatially varying input gratings. Furthermore, the model may be extended to polarization sensitive or insensitive input gratings and arbitrary incident polarization state ensembles.

The disclosed model can provide the upper bound of the input efficiency, along with the corresponding characteristics of the input coupler, such as the grating diffraction efficiencies and the Jones matrix of the polarization management components to achieve the optimal input efficiency. It is demonstrated that polarization management can improve the upper bound of input efficiency. Moreover, the model can be applied to utilize how the optimal input efficiency of a uniform input grating varies with geometric parameters, including the waveguide thickness, the projector pupil size, and the projector pupil relief distance. These determinations are important in the design of a highly efficient waveguide combiner system. Finally, the model provides a solid theoretical foundation for approaches that utilize polarization management to increase the input efficiency.

In accordance with various embodiments, a diffraction efficiency of an input grating may be represented as the ratio between diffracted power towards a target order and the incident power. The input efficiency may be represented as the ratio between the guided power in the waveguide after completing interactions with the input grating and the incident power from the projector. The diffraction efficiency and input efficiency may be defined for a respective FOV.

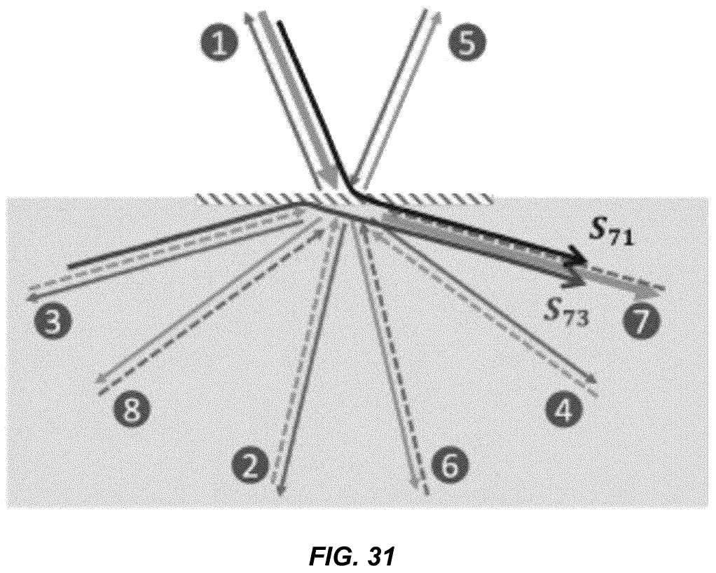

To calculate the input efficiency, consider the scattering matrix of the input grating for each FOV. For a specific incident angle in air, various scattering channels are illustrated in FIG. 31, where it is assumed that only the zeroth diffraction order exists in air, and three diffraction orders (e.g., −1^{st}, 0^{th} and +1^{st}) exist in the waveguide. For example, when light is incident from channel 1, channel 5 is the 0^{th} order reflection channel, channel 6 is the 0^{th} order transmission channel, and channels 7 and 8 are the +1^{st} and −1^{st} order diffraction channels respectively. With such channel labeling, the scattering matrix of this input grating may be represented as

$$S = [ \begin{matrix}0 & 0 & 0 & 0 & {S}_{15} & {S}_{16} & {S}_{17} & {S}_{18} \\ 0 & 0 & 0 & 0 & {S}_{25} & {S}_{26} & {S}_{27} & {S}_{28} \\ 0 & 0 & 0 & 0 & {S}_{35} & {S}_{36} & {S}_{37} & {S}_{38} \\ 0 & 0 & 0 & 0 & {S}_{45} & {S}_{46} & {S}_{47} & {S}_{48} \\ {S}_{51} & {S}_{52} & {S}_{53} & {S}_{54} & 0 & 0 & 0 & 0 \\ {S}_{61} & {S}_{62} & {S}_{63} & {S}_{64} & 0 & 0 & 0 & 0 \\ {S}_{71} & {S}_{72} & {S}_{73} & {S}_{74} & 0 & 0 & 0 & 0 \\ {S}_{81} & {S}_{82} & {S}_{83} & {S}_{84} & 0 & 0 & 0 & 0\end{matrix} ] . \qquad ( 1 )$$

Each block in this scattering matrix is a 2×2 matrix since there are two orthogonal polarizations. Typical input gratings satisfy Lorentz Reciprocity. Thus, the scattering matrix is symmetric, i.e., S=S^{T}. Furthermore, the input gratings are usually made of low-loss dielectric material and the absorption at the input gratings can be neglected. With the assumption of energy conservation, the scattering matrix is unitary, i.e., S†S=I. It is also assumed that higher order diffraction is negligible. For instance, for light incident from channel 3, channel 8 is the −2^{nd} order diffraction, which is negligible. Moreover, many diffractive gratings in waveguide combiners have a slant feature, such as slanted surface relief gratings or Bragg gratings with slanted Bragg planes, such that light is dominantly diffracted into one order. It is also assumed that only one diffraction order dominates the diffraction for each incident channel and non-dominant diffraction orders may be neglected.

In view of the foregoing, the scattering matrix can be simplified to

$$S = [ \begin{matrix}0 & 0 & 0 & 0 & {S}_{51}^{T} & {S}_{61}^{T} & {S}_{71}^{T} & 0 \\ 0 & 0 & 0 & 0 & {S}_{52}^{T} & {S}_{62}^{T} & 0 & {S}_{82}^{T} \\ 0 & 0 & 0 & 0 & 0 & {S}_{63}^{T} & {S}_{73}^{T} & 0 \\ 0 & 0 & 0 & 0 & {S}_{54}^{T} & 0 & 0 & {S}_{84}^{T} \\ {S}_{51} & {S}_{52} & 0 & {S}_{54} & 0 & 0 & 0 & 0 \\ {S}_{61} & {S}_{62} & {S}_{63} & 0 & 0 & 0 & 0 & 0 \\ {S}_{71} & 0 & {S}_{73} & 0 & 0 & 0 & 0 & 0 \\ 0 & {S}_{82} & 0 & {S}_{84} & 0 & 0 & 0 & 0\end{matrix} ] . \qquad ( 2 )$$

Since the scattering matrix is unitary,

$${S}_{71} {S}_{71}^{†} + {S}_{73} {S}_{73}^{†} = I . \qquad ( 3 )$$

Equation 3 may be reorganized as I−S₇₃S†₇₃=S₇₁S†₇₁, where the left-hand side is related to the outcoupling, and the right-hand side is related to the diffraction efficiency. In the simplified case of a polarization insensitive grating, these 2×2 matrices S₇₁ and S₇₃ become complex numbers s₇₁ and s₇₃. Then, the physical meanings of Eq. 3 can be straightforwardly interpreted as follows. The diffraction efficiency is α=|s₇₁|². When the guided light interacts with the input grating, only |s₇₃|²=1−α of the guided light remains. Therefore, Eq. 3 is a quantitative statement that the higher the diffraction efficiency of the grating, the larger the chance of outcoupling.

The analysis of the scattering matrix may proceed by applying singular value decomposition (SVD) to these 2×2 blocks of the scattering matrix:

$${S}_{71} = {U}_{1} {\sum }_{1} {V}_{1}^{†} , \qquad ( 4 )$$

$${S}_{73} = {U}_{3} {\sum }_{3} {V}_{3}^{†} , \qquad ( 5 )$$

where U₁ and U₃ are the left-singular vectors of S₇₁ and S₇₃, respectively, V₁ and V₃ are the right-singular vectors of S₇₁ and S₇₃, respectively, and Σ₁ and Σ₃ are diagonal matrices denoting the singular values of S₇₁ and S₇₃ respectively. The terms Σ₁ and Σ₃ may be denoted as:

$${\sum }_{1} = [ \begin{matrix}\sqrt{{α}_{1}} & 0 \\ 0 & \sqrt{{α}_{2}}\end{matrix} ] , \qquad ( 6 )$$

$$and$$

$${\sum }_{3} = [ \begin{matrix}\sqrt{1 - {α}_{1}} & 0 \\ 0 & \sqrt{1 - {α}_{2}}\end{matrix} ] , \qquad ( 7 )$$

where α₁ and α₂ have the physical meaning of diffraction efficiency. It is assumed α₁≥α₂. If the grating is polarization insensitive for a given FOV, α₁=α₂. Alternatively, if the grating is polarization sensitive at a given FOV, α₁≠α₂. With the form of Σ₁ and Σ₃ and the unitary constraint (Eq. 3), it may be revealed that,

$${U}_{1} = {U}_{3} . \qquad ( 8 )$$

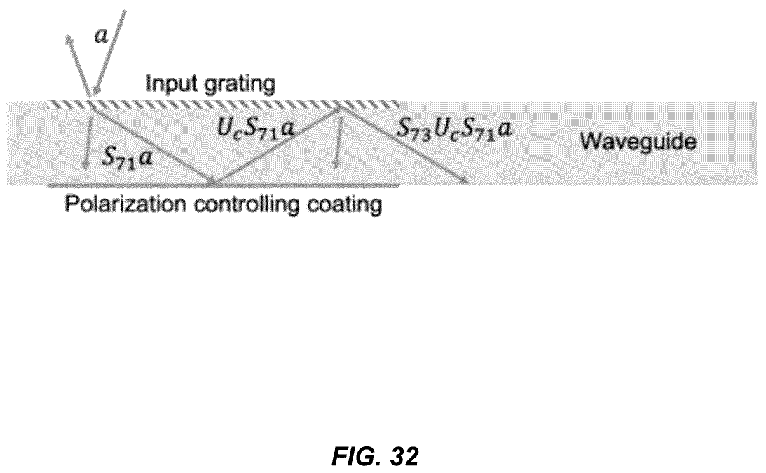

Without loss of generality, it may be assumed that there is a polarization controlling coating in the input grating region, as shown in FIG. 32. A polarization controlling coating may include an optically birefringent material, for example. A polarization controlling coating may be configured to induce a different phase delay to different polarizations of incident light. The polarization management functionality may also be combined into the input grating. To describe the light propagating from the completion of an interaction with the input grating to the onset of the next interaction with the input grating, a 2×2 matrix, U_{c}, may be used to represent the round-trip phase accumulation and the reflection phases of the polarization control coating.

### 1.1. Spatially Uniform Input Gratings

According to some embodiments, the input efficiency of a uniform input grating is considered. With the aforementioned notations, an analysis may be made of the guided power after the light interacts with the input grating n times. In the first interaction, incident light is diffracted into guided light, while in the subsequent interactions, part of the guided light may be outcoupled and the rest remains guided.

The amplitude of the incident light is denoted a, which is a 2-vector representing the amplitudes of two polarizations. To simplify the normalization with respect to the incident power, it may be assumed that a is normalized, i.e., a†a=1. After interacting with the grating for the first time, the guided amplitude is S₇₁a. With a round-trip passage in the waveguide and a second interaction with the grating, the guided amplitude is S₇₃U_{c}S₇₁a. Thus, after interacting with the grating for n times, the guided amplitude (bn) is,

$${b}_{n} = {( {S}_{73} {U}_{c} )}^{n - 1} {S}_{71} a . \qquad ( 9 )$$

The corresponding normalized guided power after an n-time interaction is,

$${P}_{n} = {b}_{n}^{†} {b}_{n} . \qquad ( 10 )$$

With the singular value decomposition (Eqs. 4 and 5) and the condition of Eq. 8, Eq. 9 may be rewritten as,

$${b}_{n} = {{U}_{3} ( {\sum }_{3} U )}^{n - 1} {\sum }_{1} {V}_{1}^{†} a , \qquad ( 11 )$$

where U=V†₃U_{c}U₃ and U is a unitary matrix. Similarly, the guided power of Eq. 10 can be rewritten as,

$${P}_{n} = {a}^{†} {V}_{1} {\sum }_{1} {( {U}^{†} {\sum }_{3} )}^{n - 1} {( {\sum }_{3} U )}^{n - 1} {\sum }_{1} {V}_{1}^{†} a . \qquad ( 12 )$$

When the incident light does not have a pure polarization, the incident polarization ensemble can be represented by a density matrix ρ. For instance, for polarized incident light with amplitude a, ρ=aa†. For unpolarized incident light,

$$ρ = [ \begin{matrix}0.5 & 0 \\ 0 & 0.5\end{matrix} ] .$$

For a general incident polarization ensemble, the guided power after an n-time interaction is,

$${P}_{n} = Tr [ ρ {V}_{1} {\sum }_{1} {( {U}^{†} {\sum }_{3} )}^{n - 1} {( {\sum }_{3} U )}^{n - 1} {\sum }_{1} {V}_{1}^{†} ] , \qquad ( 13 )$$

where Tᵣ represents the trace of a matrix.

Equation 13 provides a quantitative calculation of the guided power after interacting with the input grating n times, with an arbitrary incident polarization state ensemble. From Eq. 13, it may be shown that the most significant characteristics of the input grating are the singular values (Σ₁) of the diffraction Jones matrix S₇₁ and its right-singular vectors (V₁).

The essence of polarization control is to tune U and V₁ to control the guided power. U may be controlled with a polarization controlling layer after light first interacts with the input grating or as a part of the input grating, while V₁ may be controlled with a polarization controlling layer before the light incident on the input grating or as a part of the input grating. To obtain the upper bound of the input efficiency, these characteristics of the input grating and polarization controlling layer may be appropriately tuned.

It can be shown that the upper bound of the input efficiency of polarization sensitive gratings is higher than that of polarization insensitive gratings. Such improvement exists for either polarized input or unpolarized input. Since the input grating is polarization sensitive, after the light interacts with the input grating for the first time, the diffracted light has one dominant polarization. With polarization management, the dominant polarization of the diffracted light can be converted to the polarization that has the smaller diffraction efficiency when interacting with the input grating again.

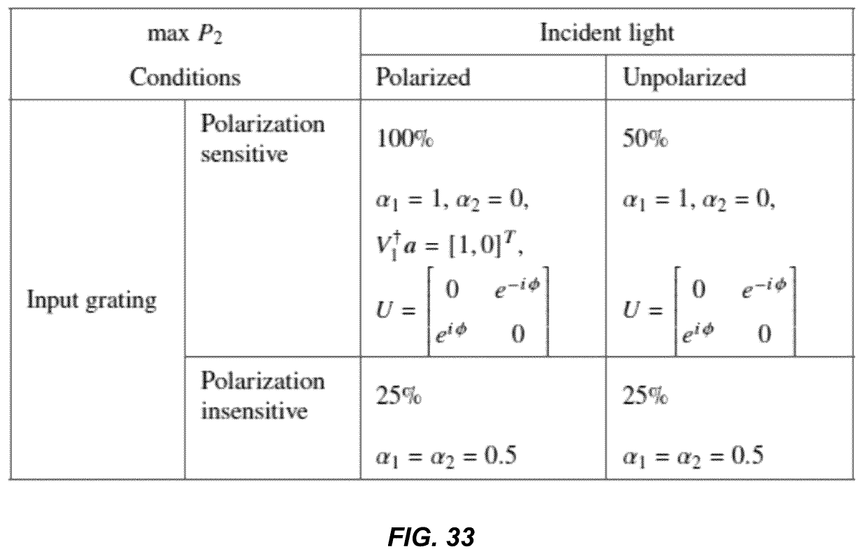

As a simplified example, consider the maximum P₂, which is the guided power after interacting with the input grating 2 times. Depending on whether the input grating is polarization sensitive or not and whether the incident light is polarized or unpolarized, the maximum P₂ and the required conditions to achieve the maximum P₂ are summarized in FIG. 33.

When the input grating is polarization sensitive, the maximum P₂ is achieved when α₁=1 and α₂=0. The physical meaning is that the input grating diffracts one polarization with 100% efficiency, while it does not respond to the orthogonal polarization. Such high polarization selectivity has been demonstrated in polarization volume gratings. Further, the requirement for the polarization management component is

$$U = [ \begin{matrix}0 & {e}^{- i ∅} \\ {e}^{i ∅} & 0\end{matrix} ] ,$$

where ϕ is an arbitrary phase and the global phase is omitted.

In some embodiments, the function of the polarization controlling layer is to convert the polarization state that is the left-singular vector of S₇₁ (or S₇₃) corresponding to the larger singular value (\sqrt{a1}) to the polarization state that is the right-singular vector of S₇₃ corresponding to the larger singular value (\sqrt{1−a2}. If the incident light is polarized, the maximum P₂ is 100%, which is achieved when the right-singular vector of S₇₁ corresponding to the larger singular value (\sqrt{a1} matches with the incident polarization state (a)). If the incident light is unpolarized, the maximum P₂ is 50%, which means one polarization is completely diffracted when it interacts with the input grating for the first time and undergoes no outcoupling when it interacts with the input grating for the second time. On the contrary, when the input grating is polarization insensitive, the maximum P₂ is 25% independent of the incident polarization state ensemble. The maximum P₂ is achieved when the diffraction efficiency of the input grating is 50%.

Next, the incident pupil based on the times of interaction with the input grating for each FOV may be segmented. This segmentation depends on geometric and diffraction parameters, such as the projector pupil size and location, the chosen FOV, the wavelength, the input grating size, shape, location, pitch, and orientation, and the waveguide index and thickness.

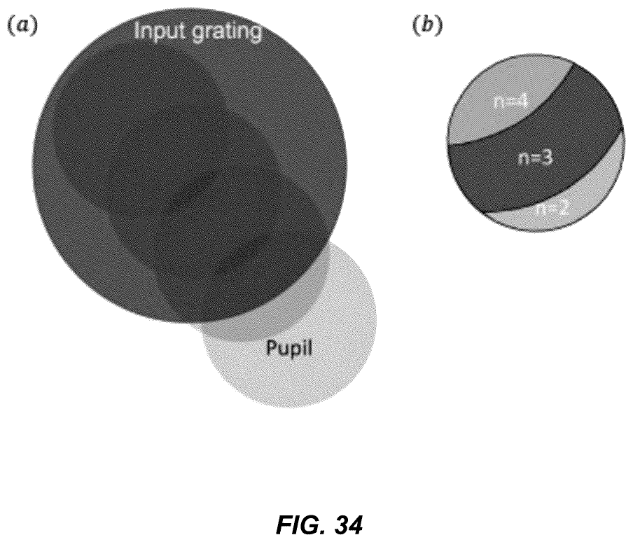

Referring to FIG. 34, and initially FIG. 34A, shown are the locations of the incident pupil when it interacts with the input grating, possibly with multiple interactions. Then, the incident pupil based on the number of interactions with the input grating can also be segmented, as illustrated in FIG. 34B.

With the pupil segmentation and the normalized guided power after n interactions Pₙ, the input efficiency can be calculated by taking an average over different segmentations. If the intensity distribution is uniform, the input efficiency is,

$$η = \frac{{\sum }_{n} {A}_{n} {P}_{n}}{{\sum }_{n} {A}_{n}} , \qquad ( 14 )$$

where Aₙ is the area of the incident pupil segmentation with n interactions with the input grating. More generally if the intensity distribution of the incident light is described by I (\vec{r}), the input efficiency is,

$$η = \frac{{\sum }_{n} {P}_{n} {\int }_{n} I ( \vec{r} ) {d}^{2} \vec{r}}{\int I ( \vec{r} ) {d}^{2} \vec{r}} , \qquad ( 15 )$$

where ∫n is the integration within the pupil segmentation of n interactions. In summary, with Eqs. 13 and 15, the input efficiency for each FOV can be calculated deterministically. Formally, the input efficiency (η) is a function of the incident polarization state ensemble (ρ), the scattering matrix blocks of the input grating (S₇₁, S₇₃) and the polarization control layer (U_{c}), the intensity distribution of the incident light (I (\vec{r}), and the set of parameters leading to the segmentation of the incident pupil (denoted as X), i.e.,

$$η = η ( ρ , {S}_{71} , {S}_{73} , {U}_{c} , I ( \vec{r} ) , X ) . \qquad ( 16 )$$

The optimization of the input efficiency can be written in the following form:

$${maximize}_{{S}_{71} , {S}_{73} , {U}_{c}} η ( ρ , {S}_{71} , {S}_{73} , {U}_{c} , I ( \vec{r} ) , X ) \qquad ( 17 )$$

With singular value decomposition (SVD), the only tunable parameters are the diffraction efficiencies α₁, α₂, and the unitary matrices U (and possibly V₁ when the incident light is polarized). The number of independent degrees of freedom in this optimization problem is few and the global optimum can be obtained. The optimized η is the maximum input efficiency for the FOV, and the corresponding S₇₁, S₇₃, U_{c} are the characteristics of the grating and the polarization control layer. This theoretical model can be used to deterministically calculate and optimize the input efficiency for a uniform input grating.

### 1.2. Spatially Varying Input Gratings

In accordance with some embodiments, the application of the presently-disclosed model may be extended to spatially varying input gratings. Compared with a uniform input grating, the characteristics of the input grating (S₇₁, S₇₃) and the polarization controlling layer (U_{c}) may be spatially dependent.

In conjunction with a spatially varying input grating, consider the translation operator T to describe the translation of the pupil location from one interaction with the input grating to the next interaction, as illustrated in FIG. 34A. The displacement between consecutive interactions may be represented as \vec{d}=[dx, dy]^{T}. The operator describing such translational transformation is,

$${T}_{\vec{d}} \vec{r} = \vec{r} + \vec{d} . \qquad ( 18 )$$

With k translations, the transformation may be denoted as

$${T}_{\vec{d}}^{k} \vec{r} = \vec{r} + k \vec{d} . \qquad ( 19 )$$

Considering the incident light with amplitude a(\vec{r}) that is incident at location \vec{r}, a physical interpretation of the amplitude a(\vec{r}) may be such that its modulus squared represents the incident intensity at \vec{r}. After interacting with the grating n times, the amplitude of the guided light is

$${b}_{u} ( \vec{r} ) = 𝒯 {\prod }_{k = 1}^{n - 1} [ {S}_{73} ( {T}_{\vec{d}}^{k} \vec{r} ) {U}_{c} ( {T}_{\vec{d}}^{k} \vec{r} ) ] {S}_{71} ( \vec{r} ) a ( \vec{r} ) . \qquad ( 20 )$$

Here, τ represents the “time-ordered” product such that larger k terms are on the left side of smaller k terms. For a general incident polarization state ensemble described by a density matrix ρ, the guided intensity after n-time interaction is,

$${I}_{n} ( \vec{r} ) = Tr ( ρ ( \vec{r} ) {\{ 𝒯 {\prod }_{k = 1}^{n - 1} [ {S}_{73} ( {T}_{\vec{d}}^{k} \vec{r} ) {U}_{c} ( {T}_{\vec{d}}^{k} \vec{r} ) ] {S}_{71} ( \vec{r} ) \}}^{†} \{ 𝒯 {\prod }_{k = 1}^{n - 1} [ {S}_{73} ( {T}_{\vec{d}}^{k} \vec{r} ) {U}_{c} ( {T}_{\vec{d}}^{k} \vec{r} ) ] {S}_{71} ( \vec{r} ) \} ) {I}_{inc} ( \vec{r} ) . \qquad ( 21 )$$

Equation 21 is applicable to spatially varying intensity and spatially varying polarization states. The input efficiency for the spatially varying input grating is,

$$η = \frac{{\sum }_{n} {\int }_{n} {I}_{n} ( \vec{r} ) {d}^{2} \vec{r}}{\int {I}_{inc} ( \vec{r} ) {d}^{2} \vec{r}} . \qquad ( 22 )$$

Equation 22 is an extension of Eq. 15. With a spatially varying input grating, the number of tunable degrees of freedom may be much larger than that of a uniform input grating. Thus, the upper bound of the input efficiency is generally higher than that of a uniform input grating. Practically, the efficiency limit depends on the acceptable spatial-varying rate because drastic spatial variations may reduce the resolution of the waveguide combiner.

### 2. Quantitative Evaluations

Representative examples are considered numerically to illustrate various aspects of the presently-disclosed theoretical analysis of input efficiency. Three representative cases include: (1) a polarization insensitive input grating, (2) a polarization sensitive input grating with unpolarized input light, and (3) a polarization sensitive input grating with polarized input light.

To numerically calculate the normalized guided power after interacting with the uniform input grating n times, Eq. 13 is simplified for each case. The input grating efficiency may be numerically optimized using the L-BFGS-B method in the SciPy package. Provided are optimal input grating efficiency and the corresponding grating diffraction efficiency. To characterize the input efficiency and uniformity over the considered FOVs, the harmonic mean input efficiency over the FOVs are calculated and a minimum-to-maximum uniformity is defined as the ratio between the minimum and maximum input efficiency over the FOVs.

The quantitative numerical results depend on the system parameters. As a representative example, a typical set of system parameters may be chosen as follows: the diameter of a circular exit pupil of the projector is 2 mm; the intensity distribution is uniform over the circular projector pupil; the projector pupil relief distance between the projector exit pupil and the input grating on the waveguide is 0.5 mm; the FOV of the projector is 50×50 degrees; and the central wavelength of the single-color projector is 532 nm.

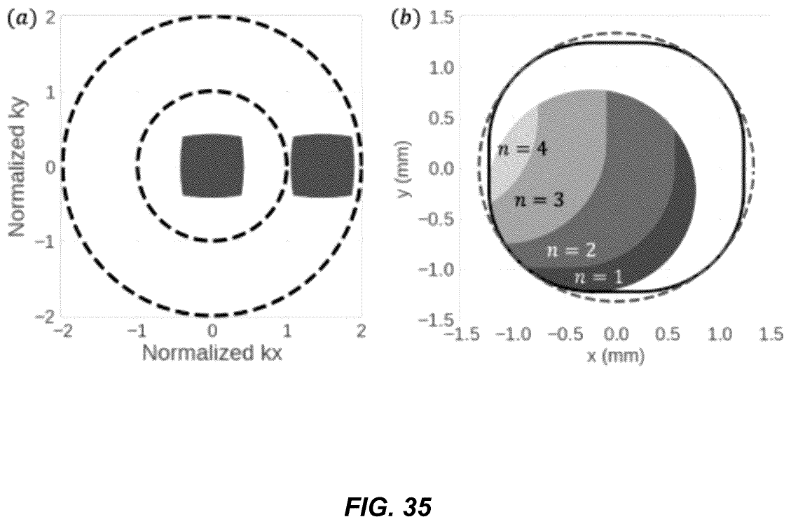

With reference to FIG. 35, in representative examples, the waveguide is made of glass with a refractive index equal to 2. Transverse wavevectors are normalized with respect to the free space wavevector. The dashed inner circle with radius 1 indicates the largest normalized wavevector in free space. The dashed outer circle with radius 2 indicates the largest normalized wavevector of propagating waves in the substrate. The waveguide thickness is 0.5 mm. To guide the whole FOV, the input grating has a pitch of 360 nm and a wavevector orientation along the x-direction, as illustrated in FIG. 35A. It is assumed that the input grating covers and only covers the whole region that is illuminated by the projector, as illustrated in FIG. 35B. Such an input grating may be referred to as the minimum covering input grating. In FIG. 35B, the solid curve represents the minimum covering input grating outline. The dashed curve represents a circle with radius 1.33 mm. The shaded circle is the exit pupil of the projector that is projected to the input grating with respect to a FOV (θₓ=25°, θ_{y}=25°). The different regions represent the pupil segmentations corresponding to 1, 2, 3, and 4 interaction events.

With the aforementioned set of parameters, the minimum covering input grating is slightly smaller than a disk with a radius of 1.33 mm. In FIG. 35B, also shown is an example of the pupil segmentation for a specific FOV, where regions represented by different shading have different interaction times with the input grating. The FOV is characterized by two angles θₓ and θ_{y} in the coordinate of a viewer facing the waveguide normally. For instance, the ray normal to the waveguide (and the eyebox) corresponds to a FOV θₓ=0 and θ_{y}=0. The ray entering the eyebox from the left has a FOV θₓ<0.

### Example 1: Polarization Insensitive Input Gratings

When the grating is polarization insensitive, i.e., α₁=α₂, Eq. 13 can be simplified as,

$${P}_{n} = {{α}_{1} ( 1 - {α}_{1} )}^{n - 1} . \qquad ( 23 )$$

In this case, there is only one tunable parameter (α₁) in the optimization problem (Eq. 17).

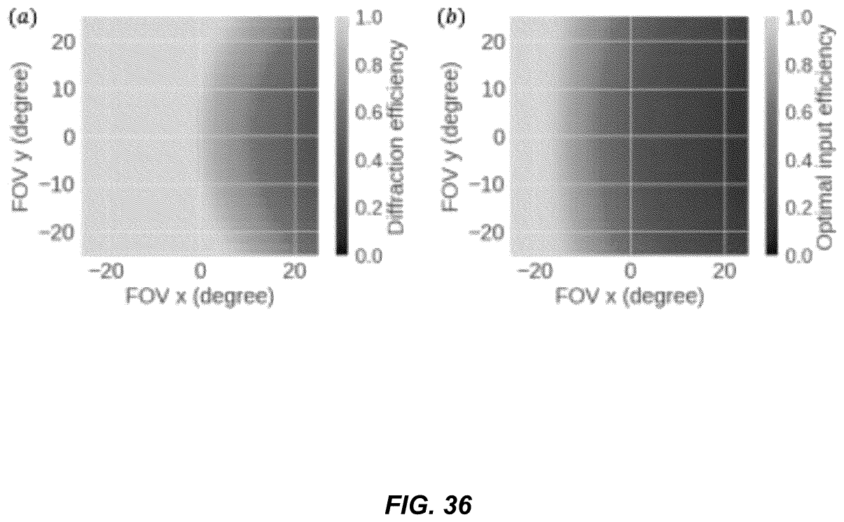

The optimal scalar diffraction efficiency of the input grating over the FOV is shown in FIG. 36A. The resulting optimal input efficiency is shown in FIG. 36B. For the left-most FOVs, the diffraction angle inside the waveguide is largest and the number of interactions with the input grating is fewest. Thus, the efficiency loss due to the outcoupling is lowest. This is consistent with the numerical results where the left-most FOVs have the highest optimal input efficiency and the right-most FOVs have the lowest optimal input efficiency.

To characterize the effective input efficiency across the whole FOV, the harmonic mean of the input efficiency is determined over the considered FOVs. In this case, the harmonic mean input efficiency is 42.8%. The ratio between the lowest input efficiency and the highest input efficiency across the FOV is defined as the minimum-to-maximum uniformity. In this numerical example, the minimum-to-maximum uniformity is 0.18.

### Example 2: Polarization Sensitive Input Gratings with Unpolarized Light

When the input light is unpolarized, the density matrix ρ=0.5 I, where I is a 2×2 identity matrix. Equation 13 can be simplified to

$${P}_{n} = 0.5 Tr [ {\sum }_{1}^{2} {( {U}^{†} {\sum }_{3} )}^{n - 1} {( {\sum }_{3} U )}^{n - 1} ] . \qquad ( 24 )$$

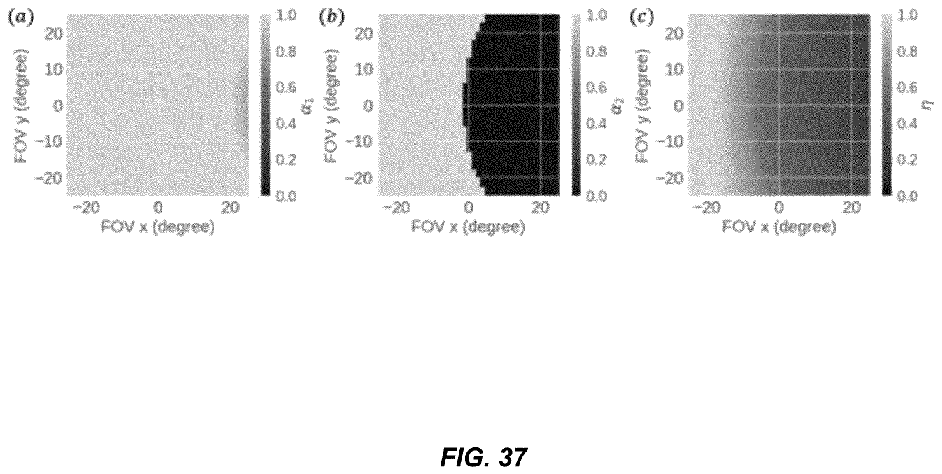

Because ∪ is a 2×2 unitary matrix, it may have the following form:

$$U = {e}^{i {ϕ}_{g}} ( cos {θ}_{u} I + i sin {θ}_{u} \hat{n} \cdot \hat{σ} ) , \qquad ( 25 )$$

where I is a 2×2 identity matrix, \hat{n}=(nₓ, n_{y}, n_{z}) with nₓ²+n_{y}²+n_{z}²=1, and \hat{σ}=(σₓ, σ_{y}, σ_{z}) are Pauli matrices. The global phase ϕ_{g} does not influence the results. Furthermore, nₓ=sin θₙ cos ϕₙ, n_{y}=sin θₙ sin ϕₙ, and n_{z}=cos θₙ. In this case, the input efficiency optimization problem (Eq. 17) has 5 tunable parameters: α₁, α₂, θᵤ, θₙ, and ϕₙ. The optimal diffraction efficiencies α₁ and α₂ are shown in FIGS. 37A and 37B, respectively. The resulting optimal input grating efficiency (η) is shown in FIG. 37C.

From the plots of α₁ and α₂, it is determined that proximate the left FOVs, both α₁ and α₂ equal 1; proximate the middle-right FOVs, α₁=1 and α₂=0; toward the right-most FOVs, α₁ is smaller than 1 and α₂=0. When both α₁ and α₂ equal 1, the polarization control layer characterized by μ is insignificant. When α₁=1 and α₂=0, U=cos ϕₙσₓ+sin ϕₙσ_{y}. Here ϕₙ can take arbitrary value and U is not unique. When α₁ is smaller than 1 and α₂=0, U is approximately equal to cos ϕₙσₓ+sin ϕₙσ_{y}. This is consistent with the previous discussion regarding P₂. The harmonic mean input efficiency is 49.0%, which is higher than Example 1. The minimum-to-maximum uniformity is 0.21, which is better than Example 1. This suggests that, if the input grating can be polarization selective over certain FOVs, the input grating efficiency and uniformity can be both improved for unpolarized input.

This result indicates that it is incorrect to assume that the polarization selective input gratings always have lower input efficiency compared with polarization unselective input gratings when the input light is unpolarized. On the contrary, over certain FOVs, the theoretical upper bound of the input efficiency is higher for the polarization-selective input gratings when the input light is unpolarized. The underlying physics supports a conclusion that although at least half of the input light cannot interact with the polarization selective input grating, the outcoupling can be reduced with polarization management, which may be more important for certain FOVs.

### Example 3: Polarization Sensitive Input Gratings with Polarized Light

When the input light is polarized, the input vector can be denoted as Via, such that the density matrix ρ=V₁aa†V†. Equation 13 can be simplified to

$${P}_{n} = {a}^{†} {\sum }_{1} {( {U}^{†} {\sum }_{3} )}^{n - 1} {( {\sum }_{3} U )}^{n - 1} {\sum }_{1} a . \qquad ( 26 )$$

The general form for a is a=[cos θₐ, sin θₐ^{eiϕa}]^{T}, omitting the global phase. In this case, the input efficiency optimization problem (Eq. 17) has 7 tunable parameters: α₁, α₂, θᵤ, θₙ, ϕₙ, θₐ, and ϕₐ.

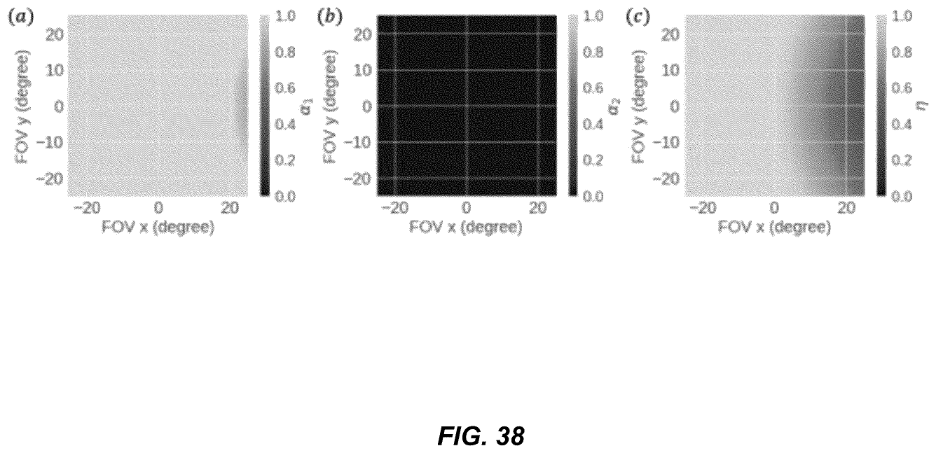

For the case of polarized incident light and a polarization sensitive input grating, the optimal diffraction efficiencies α₁ and α₂ are shown in FIGS. 38A and 38B, respectively. The resulting optimal input efficiency (η) is shown in FIG. 38C. To achieve the optimal input grating efficiency, the incident light polarization is expected to match the right singular vector of S₇₁ with respect to the larger singular value, i.e., a=[1,0]^{T}.

For a majority of the FOV, α₁=1 and becomes less than 1 towards the right FOV. For the entire FOV, α₂=0. However, at the left FOV when incident light only interacts with the input grating once for the entire pupil, both α₂ and the polarization control layer U can take an arbitrary value, since they are not involved in the input grating efficiency calculation. For the balance of the FOV region, α₂=0 deterministically. When α₁=1, and α₂=0, the polarization control layer U is approximated by cos ϕₙσₓ+sin ϕₙσ_{y}, where ϕₙ is arbitrary. When α₁<1, and α₂=0, the polarization control layer U is approximated as cos ϕₙσₓ+sin ϕₙσ_{y}. This is consistent with the previous discussion regarding P₂.

When

$$U = [ \begin{matrix}0 & {e}^{- i {∅}_{n}} \\ {e}^{i {∅}_{n}} & 0\end{matrix} ]$$

and a=[1,0]^{T}, the polarized incident light interacts with the larger diffraction efficiency of the input grating initially. After being diffracted, the guided light interacts with the smaller diffraction efficiency (α₂) and then the larger diffraction efficiency (αᵢ) rotationally. Since α₂=0, the out-coupling when the guided light interacts with the input grating for the second time is eliminated. Thus, this input efficiency is close to Example 1 when the thickness of the waveguide is doubled. In the current example, the harmonic mean input efficiency is 83.3%, and the minimum-to-maximum uniformity is 0.42, which are better than Examples 1 and 2.

### Example 4: Comparing Examples (1-3)

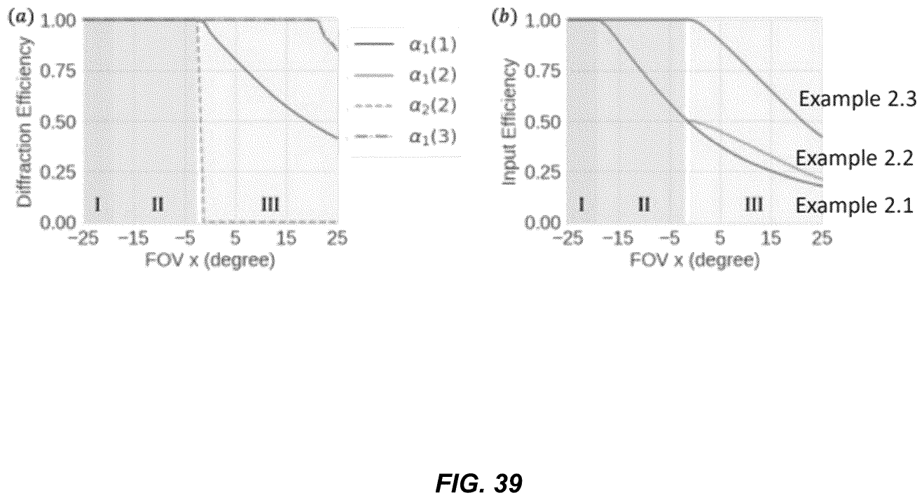

To further compare Examples 1-3, plots are generated of α₁ (and α₂ in Example 1) and η as a function of the horizontal FOV when the vertical FOV is 0°. These plots are shown in FIGS. 39A and 39B. As the FOV increases (from left FOV to right FOV), the number of interactions with the input grating increases. Thus, generally speaking, the input grating efficiency decreases, and the optimal grating diffraction efficiency decreases accordingly.

In FOV region I, the entire pupil only interacts with the input grating once. Thus, there is no out-coupling issue, and the input grating efficiency can reach 100% for all 3 Examples if the diffraction efficiency is 100%. In FOV region II, part of the pupil interacts with the input grating once and the rest of the pupil interacts with the input grating twice. With polarization management, the input grating efficiency can still reach 100% if the incident light is purely polarized. In FOV region III, input efficiency in Example 2 is greater than that in Example 1. This indicates that the efficiency loss due to out-coupling may play a more important role over the efficiency loss due to irresponsiveness to one polarization. This leads to the surprising conclusion that, under certain conditions, polarization management can increase the input efficiency even when the incident light is unpolarized.

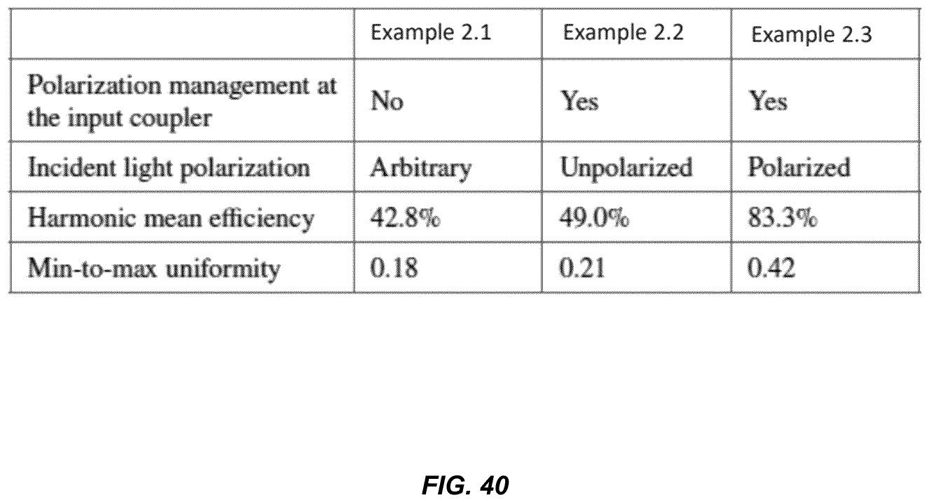

A tabulated summary of the harmonic mean input efficiency and the minimum-to-maximum uniformity for Examples 1-3 is shown in FIG. 40. When the incident light is polarized, the input grating with polarization engineering can double the efficiency and uniformity performances compared with the polarization insensitive input grating. Even when the incident is unpolarized, the polarization engineering at the input grating can still improve the efficiency and uniformity.

### 3. Evaluations

The efficiency limit of uniform input gratings as a function of waveguide thickness, projector pupil size, and projector pupil relief distance is evaluated in accordance with the assumptions of Examples 1-3. The calculations used the harmonic mean efficiency over 50×50 FOV as the metric to characterize the input grating efficiency.

### Influence of Waveguide Thickness

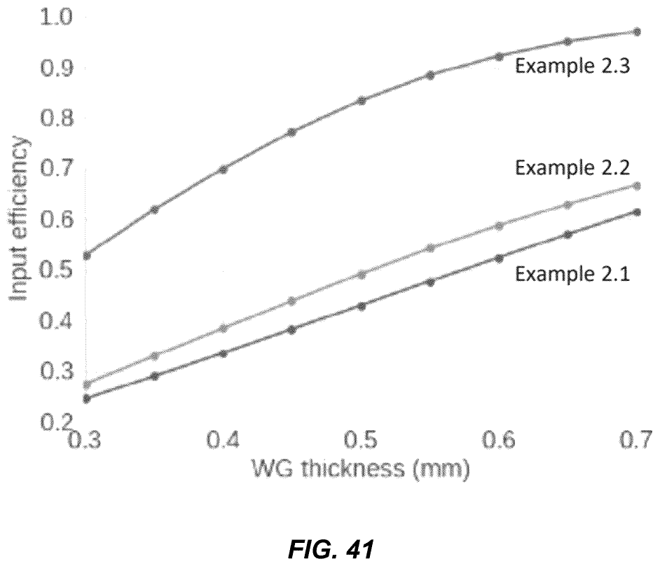

The waveguide thickness is varied over the range of 0.3 mm to 0.7 mm while maintaining the values of other parameters. The harmonic mean input efficiency as a function of waveguide thickness is shown in FIG. 41. The input efficiency decreases as the waveguide thickness decreases. Physically, the number of interactions with the input grating increases as the waveguide thickness decreases, and the out-coupling problem becomes more prominent. Thus, in addition to the mechanical challenges, a low input efficiency may introduce challenges to a thin (e.g., 0.3 mm) waveguide.

### Influence of Projector Exit Pupil Size

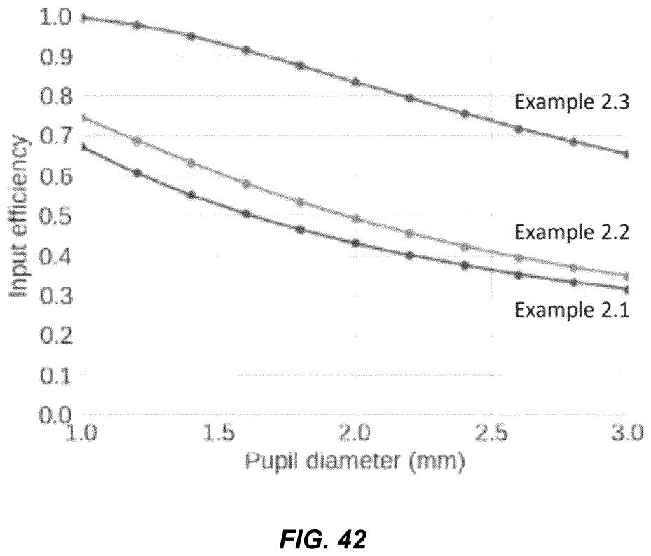

The diameter of the projector exit pupil is varied from 1 mm to 3 mm while maintaining the values of other parameters. The harmonic mean input efficiency as a function of projector exit pupil diameter is shown in FIG. 42. The input efficiency decreases as the projector exit pupil diameter increases. Thus, it is desirable, from the perspective of the input efficiency, to reduce the projector exit pupil size. Nevertheless, small projector pupil size may cause resolution drop or pupil replication density artifacts.

### Influence of Projector Pupil Relief Distance

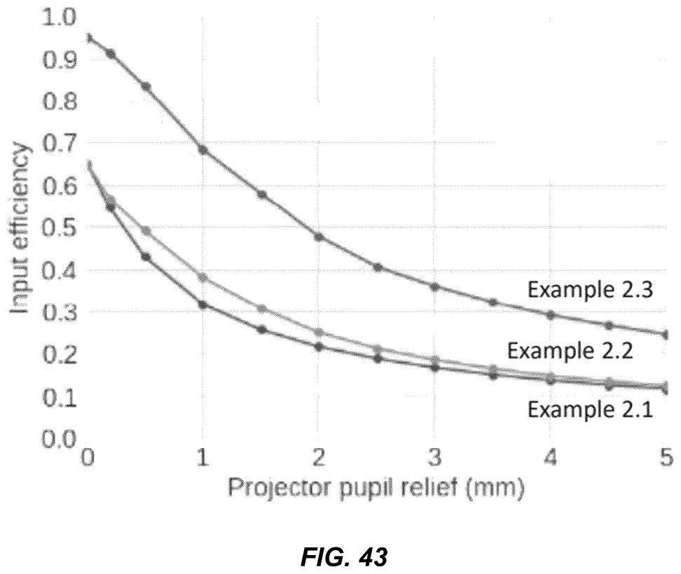

Also evaluated is the influence on input efficiency of projector pupil relief, which is the distance between the projector exit pupil and the input grating on the waveguide surface. The projector pupil relief distance is varied from 0 mm to 5 mm while keeping the other system parameters unchanged. The harmonic mean input efficiency as a function of the pupil relief is shown in FIG. 43. The input efficiency decreases as the pupil relief distance increases. One challenge of laser beam scanning projectors is the large projector pupil relief distance, which can lead to poor input efficiency. A potential solution to increase the input efficiency is to introduce spatial variation in the input grating. This solution may be especially attractive for large pupil relief distance, since the input grating size is also large, and the projected pupils for different FOVs are spatially dispersed.

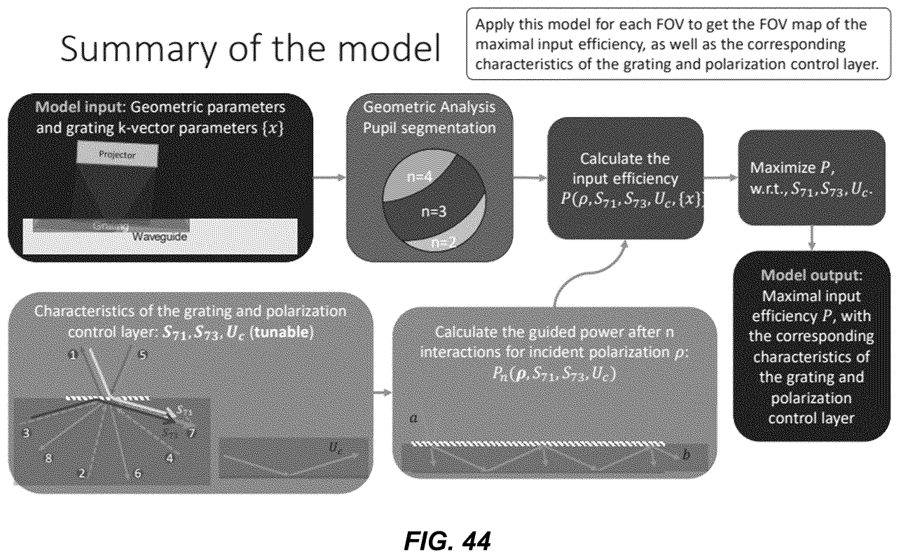

A summary of the presently-disclosed theoretical model is outlined in FIG. 44.

Disclosed is a systematic theoretical investigation of the efficiency limit of diffractive input couplers with general configurations and with the consideration of polarization management. The physics of the out-coupling problem that constrains input efficiency is considered, and key parameters that determine the input efficiency are quantitatively evaluated. The disclosed model can deterministically obtain the optimal input efficiency, along with the corresponding characteristics of the input grating and the polarization management component. The model contemplates both uniform input gratings and spatially varying input gratings and may be applied to polarization sensitive or polarization insensitive input gratings, as well as arbitrary incident polarization state ensembles.

Disclosed also are various numerical demonstrations for example uniform input gratings, and representative embodiments include (1) polarization insensitive input gratings, (2) npolarized incident light with polarization sensitive input gratings, and (3) polarized incident light with polarization sensitive input gratings. In particular embodiments, polarization management can improve the efficiency limit of input gratings. The model can be applied to determine how the optimal input efficiency of a uniform grating varies with the waveguide thickness, the projector pupil size, and the projector pupil relief distance, and may provide a fundamental understanding of the physics mechanisms governing the input efficiency, and highlights opportunities deriving from polarization management. Using the disclosed model, AR waveguide combiners may be designed and manufactured with high efficiency that enable AR glasses with a high-quality display, compact form factor, and wide accessibility.

### Example Embodiments

Example 1: A method includes determining geometric and grating parameters for an input grating coupled to a waveguide, optimizing polarization management characteristics of the input grating, evaluating an exit pupil size for light decoupled from the waveguide for a plurality of fields of view, calculating a guided power of guided light after each of n interactions of the guided light within the waveguide for arbitrary polarization states, calculating an input efficiency for light incident on the input grating for arbitrary incident polarization state ensembles, and modifying at least one of the geometric and grating parameters to increase the calculated input efficiency.

Example 2: The method of Example 1, where evaluating the exit pupil size comprises pupil segmentation.

What is claimed is:

1. An optical element comprising:
a waveguide body extending from an input end to an output end and configured to guide light by total internal reflection from the input end to the output end;
an input coupling element located proximate to the input end for coupling polarized light into the waveguide body; and
an output coupling element located proximate to the output end for coupling light having randomized polarization out of the waveguide body, wherein the waveguide body comprises an organic solid crystal configured to vary the polarization of light propagating within the waveguide body.

2. The optical element of claim 1, wherein the input coupling structure and the output coupling structure each comprise a plurality of diffractive gratings.

3. The optical element of claim 1, wherein the organic solid crystal comprises a single crystal.

4. The optical element of claim 1, wherein the organic solid crystal is optically anisotropic.

5. The optical element of claim 1, wherein the organic solid crystal has a minimum refractive index of at least approximately 1.5 and a birefringence of at least approximately 0.01.

6. The optical element of claim 1, wherein the waveguide body comprises principal refractive indices (n₁, n₂, n₃), wherein n₁≠n₂≠n₃, n₁=n₂≠n₃, n₁=n₃≠n₂, or n₂=n₃≠n₁.

7. The optical element of claim 1, wherein the waveguide body comprises a single optically anisotropic organic solid crystal layer having a thickness of less than approximately 600 micrometers.

8. The optical element of claim 1, wherein the waveguide body comprises a pair of independently oriented optically anisotropic organic solid crystal layers and has a thickness of less than approximately 1.5 mm.

9. The optical element of claim 1, wherein the waveguide body comprises three independently oriented optically anisotropic organic solid crystal layers and has a thickness of less than approximately 1.8 mm.

10. A waveguide comprising an optically anisotropic organic solid crystal substrate configured to guide and randomize the polarization of light.

11. An optical element comprising:
a waveguide body extending from an input end to an output end and configured to guide light by total internal reflection from the input end to the output end;
an input coupling element located proximate to the input end for coupling polarized light into the waveguide body; and
an output coupling element located proximate to the output end for coupling light having randomized polarization out of the waveguide body, wherein the waveguide body comprises an organic solid crystal configured to vary the polarization of light propagating within the waveguide body.

12. The optical element of claim 11, wherein the input coupling structure and the output coupling structure each comprise a plurality of diffractive gratings.

13. The optical element of claim 11, wherein the organic solid crystal comprises a single crystal.

14. The optical element of claim 11, wherein the organic solid crystal is optically anisotropic.

15. The optical element of claim 11, wherein the organic solid crystal has a minimum refractive index of at least approximately 1.5 and a birefringence of at least approximately 0.01.

16. The optical element of claim 11, wherein the waveguide body comprises principal refractive indices (n₁, n₂, n₃), wherein n₁≠n₂≠n₃, n₁=n₂≠n₃, n₁=n₃≠n₂, or n₂=n₃≠n₁.

17. The optical element of claim 11, wherein the waveguide body comprises a single optically anisotropic organic solid crystal layer having a thickness of less than approximately 600 micrometers.

18. The optical element of claim 11, wherein the waveguide body comprises a pair of independently oriented optically anisotropic organic solid crystal layers and has a thickness of less than approximately 1.5 mm.

19. The optical element of claim 11, wherein the waveguide body comprises three independently oriented optically anisotropic organic solid crystal layers and has a thickness of less than approximately 1.8 mm.

20. A waveguide comprising an optically anisotropic organic solid crystal substrate configured to guide and randomize the polarization of light.
